(19) United States
(12) Patent Application Publication
(10) Pub. No.: US 2017/0017359 A1
(43) Pub. Date: Jan. 19, 2017

(54) ELECTRONIC DEVICE FOR DISPLAYING IMAGE AND CONTROL METHOD THEREOF

(71) Applicant: Samsung Electronics Co., Ltd., Suwon-si (KR)

(72) Inventors: Eun-Jung CHOI, Yongin-si (KR); Sung-Jin YOON, Suwon-si (KR)

(21) Appl. No.: 15/201,833

(22) Filed: Jul. 5, 2016

(30) Foreign Application Priority Data
Jul. 15, 2015 (KR) 10-2015-0100301

(51) Int. Cl. G06F 3/0482; G06F 3/0484; G06F 3/0486; G06T 3/40

(52) U.S. Cl. CPC G06F 3/0482; G06T 3/40; G06F 3/04845; G06F 3/0486

(57) ABSTRACT

A control method of an electronic device including a display is provided. The control method includes displaying, on a first area of the display, an array in which a plurality of objects corresponding to a plurality of applications are arranged in a form of a curve, displaying a first object to be distinguished from other objects based on a first user input selecting the first object from among the plurality of objects, displaying, on a second area of the display, a first application corresponding to the first object among the plurality of applications, and displaying, on a third area of the display, an object for deletion which is configured to delete at least some of the plurality of objects.

### CROSS-REFERENCE TO RELATED APPLICATION(S)

This application claims the benefit under 35 U.S.C. §119(a) of a Korean patent application filed on Jul. 15, 2015 in the Korean Intellectual Property Office and assigned Serial number 10-2015-0100301, the entire disclosure of which is hereby incorporated by reference.

### TECHNICAL FIELD

The present disclosure relates to an electronic device for displaying an image and a control method thereof. More particularly, the present disclosure relates to an electronic device for displaying an application execution screen and a control method thereof.

### BACKGROUND

Recently, an electronic device, such as a smart phone or a tablet personal computer (PC), has been increasingly introduced. The smart phone or the tablet PC may store an application and may execute the stored application. A user may store a desired application in the smart phone or the tablet PC, and may carry the smart phone or the tablet PC and operate them to execute the application when the user wants to execute the application.

An electronic device of the related art provides a function of displaying a list of applications which have been used recently. When a particular input is detected, the electronic device of the related art lists and displays images of execution screens of applications which have been executed recently. In this case, the electronic device of the related art displays some or all of the images of the application execution screens. The user may identify the displayed images and designate a particular image. The electronic device of the related art displays an application execution screen corresponding to the designated image and executes the corresponding application.

In addition, the electronic device of the related art may provide a favorites menu. In this case, the electronic device of the related art may provide the favorites menu by arranging an application icon, which is configured as favorites, on a particular page of a launcher application.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device including a display having a relatively small size for portability. Therefore, when displaying an image corresponding to an application execution screen, the conventional mobile electronic device can only provide information on a relatively small number of recent applications. In addition, when providing a favorites menu, the conventional mobile electronic device simply provides an application icon, and therefore, information on the current state of the corresponding application cannot be identified.

The present disclosure has been made to solve the above described problem or other problems.

In accordance with an aspect of the present disclosure, an electronic device is provided. The electronic device includes a display, a processor that is electrically connected to the display, and a memory that is electrically connected to the processor, wherein the memory, at the time of execution, may store instructions that instruct the processor to display, on a first area of the display, an array in which a plurality of objects corresponding to a plurality of applications are arranged in a form of a curve, display a first object to be distinguished from other objects on the basis of a first user input selecting the first object from among the plurality of objects, display, on a second area of the display, a first application corresponding to the first object among the plurality of applications, and display, on a third area of the display, an object for deletion which is configured to delete at least some of the plurality of objects.

In accordance with another aspect of the present disclosure, a control method of an electronic device including a display may is provided. The control method includes displaying, on a first area of the display, an array in which a plurality of objects corresponding to a plurality of applications are arranged in a form of a curve, displaying a first object to be distinguished from other objects on the basis of a first user input selecting the first object from among the plurality of objects, displaying, on a second area of the display, a first application corresponding to the first object among the plurality of applications, and displaying, in a third area of the display, an object for deletion which is configured to delete at least some of the plurality of objects.

In accordance with another aspect of the present disclosure, an electronic device is provided. The electronic device includes a display, a processor electrically connected to the display, and a memory electrically connected to the processor, wherein the memory, at the time of execution, may store instructions that control the processor to display a first area in which a detected input is allocated to a middleware layer, display a second area in which a detected input is allocated to an application layer, and allocate an input detected in the first area to the middleware layer or allocate an input detected in the second area to the application layer, and output an operation corresponding to the allocated input.

In accordance with another aspect of the present disclosure, a control method of the electronic device is provided. The control method includes displaying a first area in which a detected input is allocated to a middleware layer, displaying a second area in which a detected input is allocated to an application layer, allocating an input detected in the first area to the middleware layer or allocating an input detected in the second area to the application layer, and outputting an operation corresponding to the allocated input.

Another aspect of the present disclosure is to provide an electronic device for displaying an object corresponding to an application and an application execution screen corresponding to at least one of objects, and a control method of the electronic device. According to various embodiments of the present disclosure, an object corresponding to an application can be displayed in a relatively small size, and therefore, information on multiple recent applications can be identified. According to various embodiments of the present disclosure, an object can be easily operated by a user, and therefore, an application execution state can be easily identified.

According to various embodiments of the present disclosure, an input detected in some areas of a display can be processed in a middleware layer, and an input detected in other areas can be processed in an application layer. Therefore, the detected input can be flexibly used in the middleware layer and the application layer, and various electronic device operations can be performed.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device and a network according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a flowchart illustrating a control method of an electronic device according to various embodiments of the present disclosure;

FIGS. 5A to 5C are conceptual diagrams of an electronic device according to various embodiments of the present disclosure;

FIG. 6 is a flowchart illustrating a control method of an electronic device according to various embodiments of the present disclosure;

FIGS. 7A and 7B are conceptual diagrams of an electronic device according to various embodiments of the present disclosure;

FIG. 8 is a flowchart illustrating a control method of an electronic device according to various embodiments of the present disclosure;

FIGS. 9A and 9B are conceptual diagrams of an electronic device according to various embodiments of the present disclosure;

FIG. 10 is a flowchart illustrating a control method of an electronic device according to various embodiments of the present disclosure;

FIGS. 11A to 11C are conceptual diagrams of an electronic device according to various embodiments of the present disclosure;

FIG. 12 is a flowchart illustrating a control method of an electronic device according to various embodiments of the present disclosure;

FIGS. 13A to 13F are conceptual diagrams of an electronic device according to various embodiments of the present disclosure;

FIG. 14 is a flowchart illustrating a control method of an electronic device according to various embodiments of the present disclosure;

FIGS. 15A to 15D are conceptual diagrams of an electronic device according to various embodiments of the present disclosure;

FIG. 16 is a flowchart illustrating a control method of an electronic device according to various embodiments of the present disclosure;

FIGS. 17A and 17B are conceptual diagrams of an electronic device according to various embodiments of the present disclosure;

FIG. 18 is a flowchart illustrating a control method of an electronic device according to various embodiments of the present disclosure;

FIGS. 19A to 19C are conceptual diagrams of an electronic device according to various embodiments of the present disclosure;

FIG. 20 is a block diagram of a program module according to various embodiments of the present disclosure;

FIG. 21 is a flowchart illustrating a control method of an electronic device according to various embodiments of the present disclosure;

FIG. 22 is a conceptual diagram illustrating an area according to various embodiments of the present disclosure; and

FIGS. 23A to 23D are conceptual diagrams of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the expression “have”, “may have”, “include”, or “may include” refers to the existence of a corresponding feature (e.g., numeral, function, operation, or constituent element, such as a component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a moving picture experts group phase 1 or phase 2 (MPEG-1 or MPEG-2) audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments of the present disclosure, the electronic device may be a home appliance. The smart home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, and the like), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, and the like).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments of the present disclosure, the electronic device may be a combination of one or more of the aforementioned various devices. According to some embodiments of the present disclosure, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g. an artificial intelligence electronic device) using an electronic device.

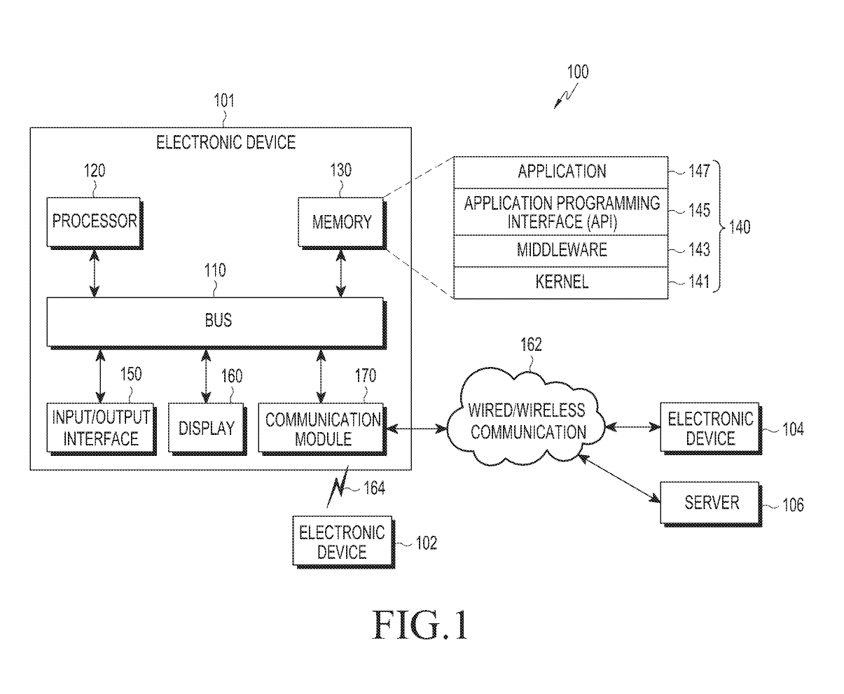

FIG. 1 is a block diagram of an electronic device and a network according to various embodiments of the present disclosure.

Referring to FIG. 1, an electronic device 101 within a network environment 100, according to various embodiments of the present disclosure, will be described with reference to FIG. 1. The electronic device 101 may include a bus 110, a processor 120, a memory 130, an input/output interface 150, a display 160, and a communication module 170. In some embodiments of the present disclosure, the electronic device 101 may omit at least one of the above elements or may further include other elements.

The bus 110 may include, for example, a circuit for connecting the elements 110 to 170 and transferring communication (for example, control messages and/or data) between the elements.

The processor 120 may include one or more of a CPU, an AP, and a communication processor (CP). The processor 120 may carry out, for example, operations or data processing relating to the control and/or communication of at least one other element of the electronic device 101.

The memory 130 may include a volatile memory and/or a non-volatile memory. The memory 130 may store, for example, instructions or data related to at least one other element of the electronic device 101. According to an embodiment of the present disclosure, the memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

For example, the kernel 141 may control or manage system resources (for example, the bus 110, the processor 120, and the memory 130) that are used to execute an operation or a function implemented in the other programs (for example, the middleware 143, the API 145, and the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign, to at least one of the application programs 147, priorities for using the system resources (for example, the bus 110, the processor 120, the memory 130, and the like) of the electronic device 101. For example, the middleware 143 may perform scheduling or load balancing on the one or more task requests by processing the one or more task requests according to the priorities assigned thereto.

The API 145 is an interface through which the applications 147 controls functions provided from the kernel 141 or the middleware 143, and may include, for example, at least one interface or function (e.g., instruction) for file control, window control, image processing, or text control.

The input/output interface 150 may function as, for example, an interface that may transfer instructions or data input from a user or another external device to the other element(s) of the electronic device 101. Furthermore, the input/output interface 150 may output the instructions or data received from the other element(s) of the electronic device 101 to the user or another external device.

Examples of the display 160 may include a liquid crystal display (LCD), a light-emitting diode (LED) display, an organic LED (OLED) display, a microelectromechanical Systems (MEMS) display, and an electronic paper display. The display 160 may display, for example, various types of contents (for example, text, images, videos, icons, or symbols) for the user. The display 160 may include a touch screen and receive, for example, a touch, gesture, proximity, or hovering input using an electronic pen or the user's body part.

The communication module 170, for example, may set communication between the electronic device 101 and an external device (for example, a first external electronic device 102, a second external electronic device 104, or a server 106). For example, the communication module 170 may be connected to a network 162 through wireless or wired communication to communicate with the external device (for example, the second external electronic device 104 or the server 106).

The wireless communication may use at least one of, for example, long term evolution (LTE), LTE-advance (LTE-A), code division multiple access (CDMA), wideband CDMA (WCDMA), universal mobile telecommunications system (UMTS), wiBro (Wireless Broadband), and global system for mobile communications (GSM), as a cellular communication protocol. In addition, the wireless communication may include, for example, short range communication 164. The short-range communication 164 may include at least one of, for example, wireless fidelity (Wi-Fi), Bluetooth, near field communication (NFC), and global navigation satellite system (GNSS). The GNSS may include at least one of, for example, a global positioning system (GPS), a Global navigation satellite system (Glonass), a Beidou navigation satellite system (hereinafter, referred to as “Beidou”), and Galileo (European global satellite-based navigation system). Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old telephone service (POTS). The network 162 may include at least one of communication networks, such as a computer network (e.g., a local area network (LAN) or a wide area network (WAN)), the Internet, and a telephone network.

Each of the first and second external electronic devices 102 and 104 may be a device which is the same as, or different from, the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (for example, the electronic devices 102 and 104 or the server 106). According to an embodiment of the present disclosure, when the electronic device 101 should perform some functions or services automatically or by request, the electronic device 101 may make a request for performing at least some of the functions related to the functions or services to another device (for example, the electronic device 102 or 104 or the server 106) instead of performing the functions or services by itself. Another electronic device (for example, the electronic device 102 or 104, or the server 106) may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

According to various embodiments of the present disclosure, the processor 120 may be electrically connected to the display 160. Further, the processor 120 may be electrically connected to the memory 130. The memory 130, at the time of execution, may store instructions that instruct the processor 120 to: display, on a first area of the display, an array in which a plurality of objects corresponding to a plurality of applications are arranged in the form of a curve; display a first object to be distinguished from other objects on the basis of a first user input selecting the first object from among the plurality of objects; display, on a second area of the display, a first application corresponding to the first object among the plurality of applications; and display, on a third area of the display, an object for deletion which is configured to delete at least some of the plurality of objects.

According to various embodiments of the present disclosure, the memory 130, at the time of execution, may store an instruction that instructs the processor 120 to change the first object having a first size into the first object having a second size and then display the latter in response to the first user input.

According to various embodiments of the present disclosure, the memory 130, at the time of execution, may store an instruction that instructs the processor 120 to change the first object having a first display attribute into the first object having a second display attribute and then display the latter, in response to the first user input.

According to various embodiments of the present disclosure, the memory 130, at the time of execution, may store an instruction that instructs the processor 120 to move the array in a first direction on the display, on the basis of a second user input which performs a drag in the first direction input in the first area, and to display a second object, which is located in a second direction opposite to the first direction with respect to the first object, to be distinguished from the remaining objects excluding the second object.

According to various embodiments of the present disclosure, the memory 130, at the time of execution, may store an instruction that instructs the processor 120 to change the size of the first object from the second size to the first size and change the size of the second object from the first size to the second size.

According to various embodiments of the present disclosure, the memory 130, at the time of execution, may store an instruction that instructs the processor 120 to delete the first object from the array, on the basis of the second user input which drags the first object and drops the dragged first object into the object for deletion.

According to various embodiments of the present disclosure, the memory 130, at the time of execution, may store an instruction that instructs the processor 120 to display a plurality of lines which connect each of the plurality of objects to the object for deletion, and to delete, from the array, the second object connected to one selected line among the plurality of objects, on the basis of the second user input selecting the one selected line from among the plurality of lines.

According to various embodiments of the present disclosure, the memory 130, at the time of execution, may store an instruction that instructs the processor 120 to edit at least one of the sequence of objects and objects which constitute the array.

According to various embodiments of the present disclosure, the memory 130, at the time of execution, may store an instruction that instructs the processor 120 to detect the second user input designating the second object from among the first object and the plurality of objects, and to display an object in which the first and second objects are grouped together, in place of the first and second objects.

According to various embodiments of the present disclosure, the memory 130, at the time of execution, may store an instruction that instructs the processor 120 to display, on the second area, a first application corresponding to the first object and a second application corresponding to the second object, when the grouped object is selected.

According to various embodiments of the present disclosure, the memory 130, at the time of execution, may store an instruction that instructs the processor 120 to determine at least one of a display location and display form of the first area, on the basis of a user's use pattern of the electronic device.

According to various embodiments of the present disclosure, the memory 130, at the time of execution, may store instructions that control the processor 120 to: display a first area in which a detected input is allocated to a middleware layer; display a second area in which a detected input is allocated to an application layer; and allocate an input detected in the first area to the middleware layer or allocate an input detected in the second area to the application layer, and output an operation corresponding to the allocated input.

According to various embodiments of the present disclosure, the memory 130 may store an instruction that controls the processor 120 to display, on the second area, an execution screen of an application corresponding to one of objects on the first area.

According to various embodiments of the present disclosure, the memory 130 may store an instruction that controls the processor 120 to allocate the input detected in the second area to the application.

According to various embodiments of the present disclosure, the memory 130 may store an instruction that controls the processor 120 to determine and display an application to be displayed on the second area, in response to the input detected in the first area.

According to various embodiments of the present disclosure, the memory 130 stores an instruction that controls the processor 120 to display a plurality of objects on the first area, wherein a first object selected from among the plurality of objects may be linked with the second area.

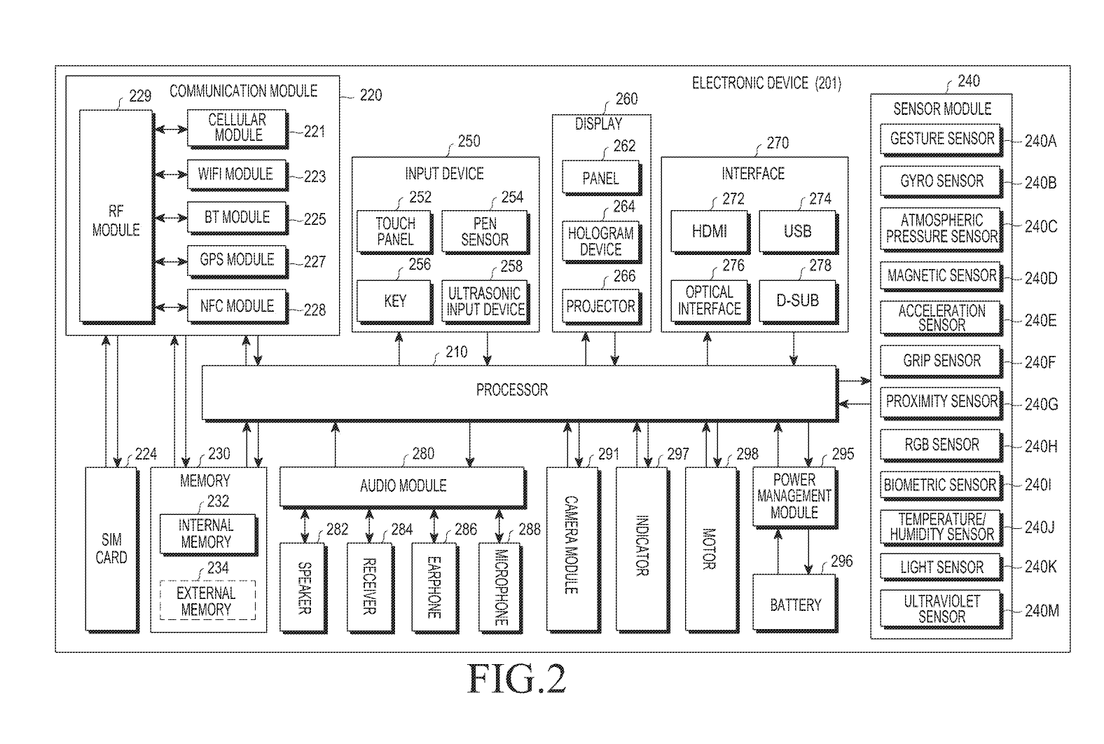

FIG. 2 is a block diagram of an electronic device according to various embodiments of the present disclosure.

Referring to FIG. 2, an electronic device 201 may include, for example, the whole or part of the electronic device 101 illustrated in FIG. 1. The electronic device 201 may include at least one AP 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an OS or an application program and perform the processing of various pieces of data and calculations. The processor 210 may be implemented by, for example, a system on chip (SoC). According to an embodiment of the present disclosure, the processor 210 may further include a graphic processing unit (GPU) and/or an image signal processor. The processor 210 may include at least some (for example, a cellular module 221) of the elements illustrated in FIG. 2. The processor 210 may load, into a volatile memory, instructions or data received from at least one (for example, a non-volatile memory) of the other elements and may process the loaded instructions or data, and may store various data in a non-volatile memory.

The communication module 220 may have a configuration that is equal or similar to that of the communication interface 170 of FIG. 1. The communication module 220 may include, for example, a cellular module 221, a Wi-Fi module 223, a Bluetooth module 225, a GNSS module 227 (e.g., a GPS module, a Glonass module, a Beidou module, or a Galileo module), an NFC module 228, and a radio frequency (RF) module 229.

The cellular module 221 may provide a voice call, an image call, a text message service, or an Internet service through, for example, a communication network. According to an embodiment of the present disclosure, the cellular module 221 may identify and authenticate the electronic device 201 within a communication network by using a subscriber identification module (for example, the SIM card 224). According to an embodiment of the present disclosure, the cellular module 221 may perform at least some of the functions that the processor 210 may provide. According to an embodiment of the present disclosure, the cellular module 221 may include a CP.

The Wi-Fi module 223, the Bluetooth module 225, the GNSS module 227, or the NFC module 228 may include, for example, a processor that processes data transmitted and received through the corresponding module. According to some embodiments of the present disclosure, at least some (two or more) of the cellular module 221, the Wi-Fi module 223, the Bluetooth module 225, the GNSS module 227, and the NFC module 228 may be included in one integrated chip (IC) or IC package.

The RF module 229 may transmit/receive, for example, a communication signal (for example, an RF signal). The RF module 229 may include, for example, a transceiver, a power amplifier module (PAM), a frequency filter, a low noise amplifier (LNA), and an antenna. According to another embodiment of the present disclosure, at least one of the cellular module 221, the Wi-Fi module 223, the BT module 225, the GPS module 227, and the NFC module 228 may transmit/receive an RF signal through a separate RF module.

The subscriber identification module 224 may include, for example, a card including a subscriber identification module and/or an embedded SIM, and may contain unique identification information (for example, an integrated circuit card identifier (ICCID)) or subscriber information (for example, an international mobile subscriber identity (IMSI)).

The memory 230 (for example, the memory 130) may include, for example, an internal memory 232 or an external memory 234. The internal memory 232 may include at least one of a volatile memory (for example, a dynamic random access memory (DRAM), a static RAM (SRAM), a synchronous dynamic RAM (SDRAM), and the like) and a non-volatile memory (for example, a one-time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash memory or a NOR flash memory), a hard disk drive, a solid state drive (SSD), and the like).

The external memory 234 may further include a flash drive, for example, a compact flash (CF), a secure digital (SD), a micro SD (Micro-SD), a mini SD (Mini-SD), an eXtreme digital (xD), a multi-media card (MMC), a memory stick, and the like. The external memory 234 may be functionally and/or physically connected to the electronic apparatus 201 through various interfaces.

The sensor module 240 may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments of the present disclosure, the electronic device 201 may further include a processor configured to control the sensor module 240 as a part of, or separately from, the processor 210, and may control the sensor module 240 while the processor 210 is in a sleep state.

The input device 250 may include, for example, a touch panel 252, a (digital) pen sensor 254, a key 256, and an ultrasonic input unit 258. The touch panel 252 may use at least one of, for example, a capacitive type, a resistive type, an infrared type, and an ultrasonic type. In addition, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic waves generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to that of the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a SD/MMC card interface, or an Infrared Data Association (IrDA) standard interface.

The audio module 280 may bilaterally convert, for example, a sound and an electrical signal. At least some elements of the audio module 280 may be included in, for example, the input/output interface 150 illustrated in FIG. 1. The audio module 280 may process sound information that is input or output through, for example, a speaker 282, a receiver 284, earphones 286, the microphone 288, and the like.

The camera module 291 is a device which may photograph a still image and a dynamic image. According to an embodiment of the present disclosure, the camera module 291 may include one or more image sensors (for example, a front sensor or a back sensor), a lens, an image signal processor (ISP) or a flash (for example, LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, and the like) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (for example, a booting state, a message state, a charging state, and the like) of the electronic device 201 or a part (for example, the processor 210) of the electronic device 201. The motor 298 may convert an electrical signal into mechanical vibrations, and may generate a vibration or haptic effect. Although not illustrated, the electronic device 201 may include a processing unit (for example, a GPU) for supporting a mobile television (TV). The processing unit for supporting mobile TV may, for example, process media data according to a certain standard, such as digital multimedia broadcasting (DMB), digital video broadcasting (DVB), or mediaFlo™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. In addition, some of the hardware components according to various embodiments may be combined into one entity, which may perform functions identical to those of the relevant components before the combination.

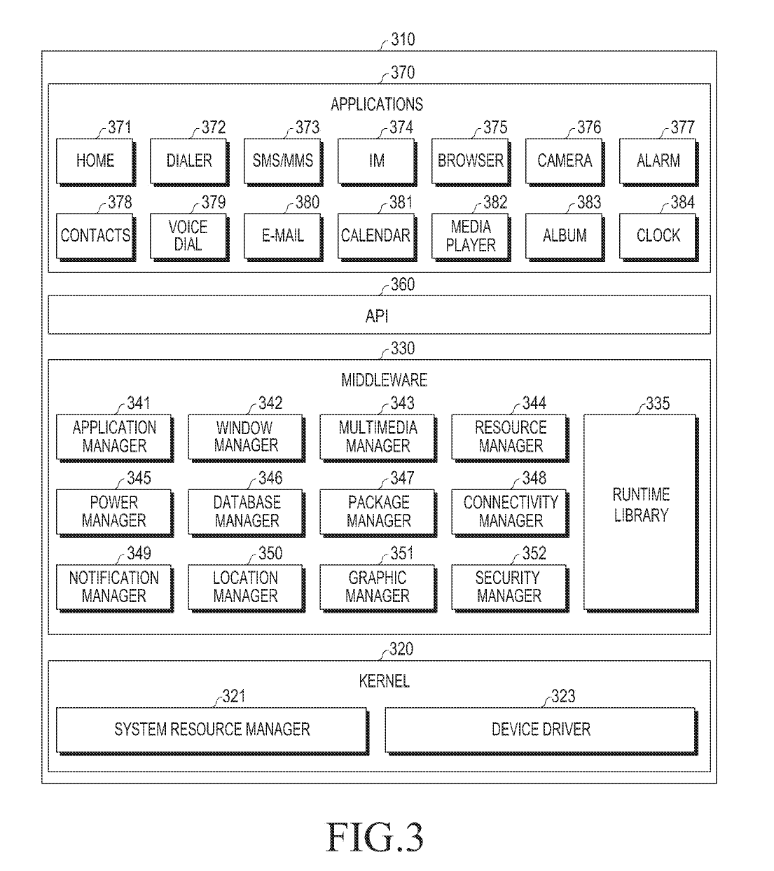

FIG. 3 is a block diagram of a program module according to various embodiments of the present disclosure.

Referring to FIG. 3, a program module 310 (for example, the program 140) may include an operating system (OS) for controlling resources related to the electronic device (for example, the electronic device 101) and/or various applications (for example, the application programs 147) executed in the OS. The OS may be, for example, Android, iOS, Windows, Symbian, Tizen, Bada, and the like.

The program module 310 may include a kernel 320, middleware 330, an API 360, and/or applications 370. At least some of the program module 310 may be preloaded on the electronic device, or may be downloaded from an external electronic device (for example, the electronic device 102 or 104, or the server 106).

The kernel 320 (for example, the kernel 141) may include, for example, a system resource manager 321 and/or a device driver 323. The system resource manager 321 may perform the control, allocation, retrieval, and the like, of system resources. According to an embodiment of the present disclosure, the system resource manager 321 may include a process manager, a memory manager, a file system manager, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function commonly required by the applications 370, or may provide various functions to the applications 370 through the API 360 so that the applications 370 can efficiently use limited system resources within the electronic device. According to an embodiment of the present disclosure, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module which a compiler uses in order to add a new function through a programming language while the applications 370 are being executed. The runtime library 335 may perform input/output management, memory management, the functionality for an arithmetic function, and the like.

The application manager 341 may manage, for example, a life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the corresponding format. The resource manager 344 may manage resources, such as a source code, a memory, a storage space, and the like of at least one of the applications 370.

The power manager 345 may operate together with a basic input/output system (BIOS) to manage a battery or power, and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection, such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic device (for example, the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a module specialized for each type of OS in order to provide a differentiated function. In addition, the middleware 330 may dynamically delete some of the existing elements, or may add new elements.

The API 360 (for example, the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application programs 147) may include, for example, one or more applications which can perform functions, such as home 371, dialer 372, short message service (SMS)/multimedia message service (MMS) 373, instant message (IM) 374, browser 375, camera 376, alarm 377, contacts 378, voice dialer 379, email 380, calendar 381, media player 382, album 383, clock 384, health care (for example, the measurement of exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic device (for example, the electronic device 101) and an external electronic device (for example, the electronic device 102 or 104). The information exchange application may include, for example, a notification relay application for transferring specific information to an external electronic device or a device management application for managing an external electronic device.

For example, the notification relay application may include a function of transferring, to the external electronic device (for example, the electronic device 102 or 104), notification information generated from other applications of the electronic device (for example, an SMS/MMS application, an e-mail application, a health management application, or an environmental information application). Further, the notification relay application can, for example, receive notification information from the external electronic device and provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or some components) or a function of adjusting the luminance (or a resolution) of the display), applications operating in the external electronic device, or services provided by the external electronic device (for example, a call service and a message service).

According to an embodiment of the present disclosure, the applications 370 may include applications (for example, a health care application of a mobile medical appliance, and the like) designated according to attributes of the external electronic device (for example, the electronic device 102 or 104). According to an embodiment of the present disclosure, the applications 370 may include an application received from the external electronic device (for example, the server 106, or the electronic device 102 or 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific IC (ASIC) chip, a field-programmable gate arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

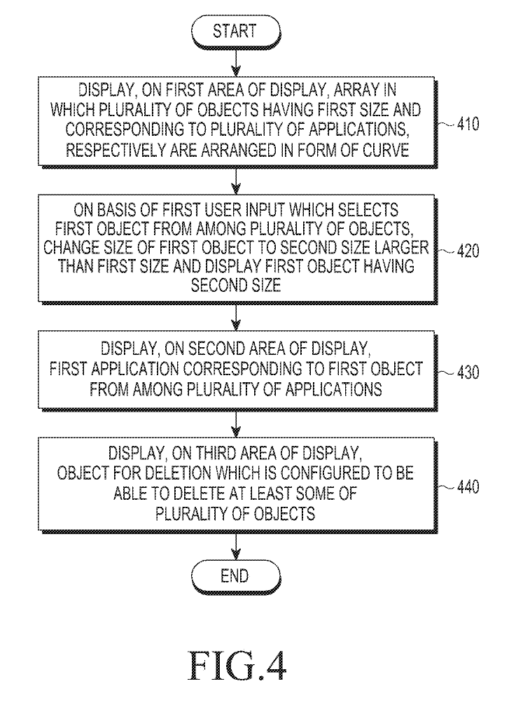

FIG. 4 is a flowchart illustrating a control method of an electronic device according to various embodiments of the present disclosure.

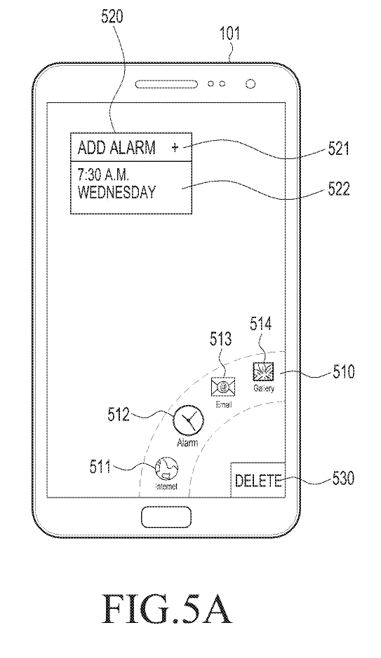

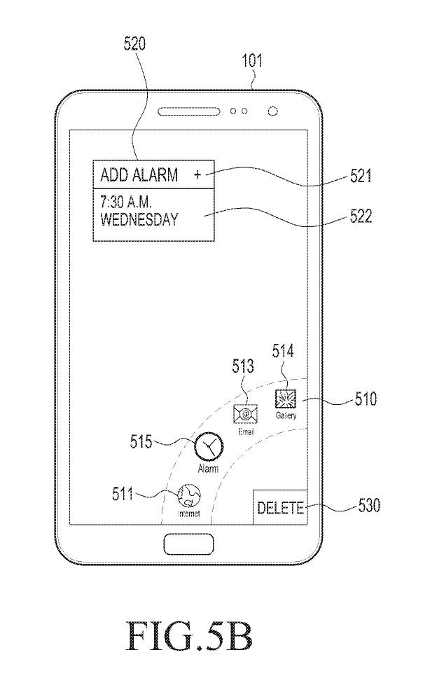

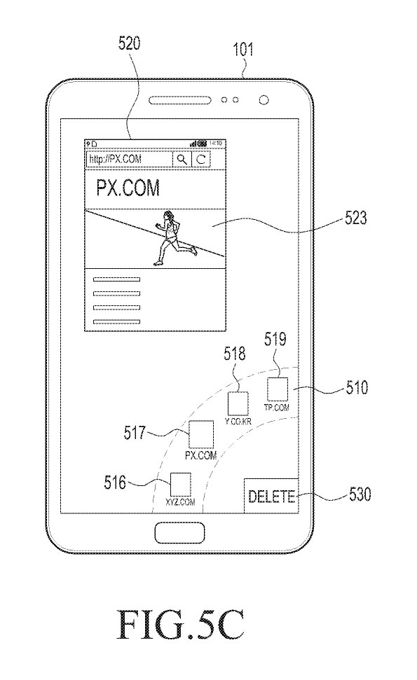

The embodiment of FIG. 4 will be more specifically described with reference to FIGS. 5A to 5C. FIG. 5A to 5C are conceptual diagrams of an electronic device according to various embodiments of the present disclosure.

Referring to FIGS. 4 and FIGS. 5A to 5C, in operation 410, the electronic device 101 may display, on a first area of a display, an array in which a plurality of objects having a first size and corresponding to a plurality of applications, respectively, are arranged in the form of a curve. Herein, the objects may be implemented as icons, webpage addresses, or thumbnails, and may be implemented in various manners according to the purpose of the array. For example, when the purpose of the array is to display a recently used application or an application that is frequently used, an object may be implemented as icons corresponding to the application. Further, the purpose of an array is to display a recently visited webpage or a webpage configured as favorites, an object on the array may be implemented as a webpage address, and the like. For example, as in FIG. 5A, the electronic device 101 may display objects 511 to 514 on a first area 510. Here, the first area 510 may be an area configured in advance or dynamically in order to display the object 511 to 514. According to various embodiments of the present disclosure, the electronic device 101 may adjust at least one of the location and form of the first area 510 to be different from that illustrated in FIG. 5A. When the first area 510 is an area on which at least one of the objects 511 to 514 may be displayed, there is no limit to the form and location of the first area 510. According to various embodiments of the present disclosure, the electronic device 101 may configure the location of the first area 510 on the basis of user information (for example, left-a hander or right-hander, the form of a grip, or user finger length information based on learning). The first area 510 is a logical area and may not be displayed on a display. Meanwhile, according to the embodiment of FIG. 5A, the electronic device 101 may configure the first area 510 in the form of a curve and may arrange objects in the form of a curve on the first area 510. Therefore, when a user grips the lower right end of the electronic device 101, the user can select the objects 511 to 514 or change the location thereof, by using the user's thumb.

In operation 420, on the basis of a first user input which selects a first object from among a plurality of objects, the electronic device 101 may change the first object into a second size that is larger than a first size and then display the first object. According to the embodiment of FIG. 5A, the user may select an alarm object 512. On the basis of the first user input selecting the alarm object 512, the electronic device 101 may display the selected alarm object 512 to be distinguished from other objects 511, 513, and 514. In an example, as in FIG. 5A, the electronic device 101 may display the selected alarm object 512 to have a size that is relatively larger than the other object 511, 513, and 514. In another example, as in FIG. 5B, the electronic device 101 may display the selected alarm object 515 to have a color or a form which different from that of the other object 511, 513, and 514. The above-described examples are merely exemplary, and therefore, if the electronic device 101 can display a selected object to be distinguished from other objects, there is no limitation. In other words, the electronic device 101 may adjust a display attribute (such as a size, a color, transparency, or a form) so that the selected object is distinguished from the other objects.

Meanwhile, the electronic device 101 may select an object which the user designates himself/herself as an object which the user selects. In other words, a first user input may be a direct selection of an object. Further, the electronic device 101 may select an object disposed in a particular location of the first area 510 as an object which the user selects. For example, according to the embodiment of FIG. 5A, the electronic device 101 may select the alarm object 512 which is the second object from the left of a first area 510. In this case, the first user input may be an input which changes locations of the objects 511 to 514 and an example of the input of changing the locations of the objects 511 to 514 will be more specifically described later on.

In operation 430, the electronic device 101 may display, on a second area of the display, a first application corresponding to the first object from among the plurality of applications. For example, as in FIG. 5A, the electronic device 101 may display, on the second area 520, execution screens 521 and 522 of an alarm application corresponding to the selected alarm object 512.

In operation 440, the electronic device 101 may display, on a third area of the display, an object for deletion which is configured to be able to delete at least some of the plurality of objects. For example, as in FIG. 5A, the electronic device 101 may display an object for deletion 530 on the third area. According to an embodiment of the present disclosure, the electronic device 101 may configure the first area 510 on the lower right side of the display in the form of a curve, and may configure and display a second area 520 as an area including at least a part of the outside of the first area 510. For example, the electronic device 101 may configure and display the second area 520 on the upper left side of the first area 510. In addition, the electronic device 101 may configure and display the third area including the object for deletion 530 inside the first area 510, i.e., on the lower right side of the first area 510.

According to an embodiment of the present disclosure, the electronic device 101 may detect a gesture for deletion (for example, drag-and-drop) from at least one of the objects 511 to 514 of the first area 510, and may delete, from the first area 510, at least one object corresponding to a start point of the gesture (for example, drag-and-drop) on the basis of the detected gesture (for example, drag-and-drop). According to various embodiments of the present disclosure, the gesture for deletion is limited to the drag-and-drop and includes a gesture which can designate a particular object. The deletion of an object will be more specifically described later on. Herein, whether a user input, such as a gesture, is performed may be determined according to whether the user input is beyond the boundary of a particular location (for example, a threshold value).

Referring to FIGS. 5A and 5B, a description has been made of an example in which the objects 511 to 514 arranged on the first area 510 are application icons. For example, the electronic device 101 may display a list of recently used application, a list of favorites applications, and the like, on the first area 510 in the form of an icon. Meanwhile, according to another embodiment of the present disclosure, the electronic device 101 may display multiple screens of one application on the first area 510, as in FIG. 5C.

Referring to FIG. 5C, the electronic device 101 may display one or more pages 516 to 519 of web browsing applications on the first area 510. In addition, the electronic device 101 may display an application execution screen 523 corresponding to a selected page 516 on the second area 520. A user may select another page on the first area 510. In response, the electronic device 101 may display an application execution screen corresponding to another selected page on the second area 520.

Meanwhile, an input detected on the second area 520 may be allocated to an application displayed on the second area 520. For example, the user may immediately execute a function related to an object displayed on a web browsing application screen by touching the web browsing application execution screen 523 displayed, as in the embodiment of FIG. 5C. In other words, the electronic device 101 according to various embodiments of the present disclosure may use an input detected on the first area 510 in adjusting an object on the first area 510 and changing an application execution screen displayed on the second area 520. More specifically, the electronic device 101 may select and display an application to be displayed on the second area on the basis of a user input detected on the first area 510. Meanwhile, the electronic device 101 may allocate the input detected on the second area 520 to an application being displayed so as to control the application.

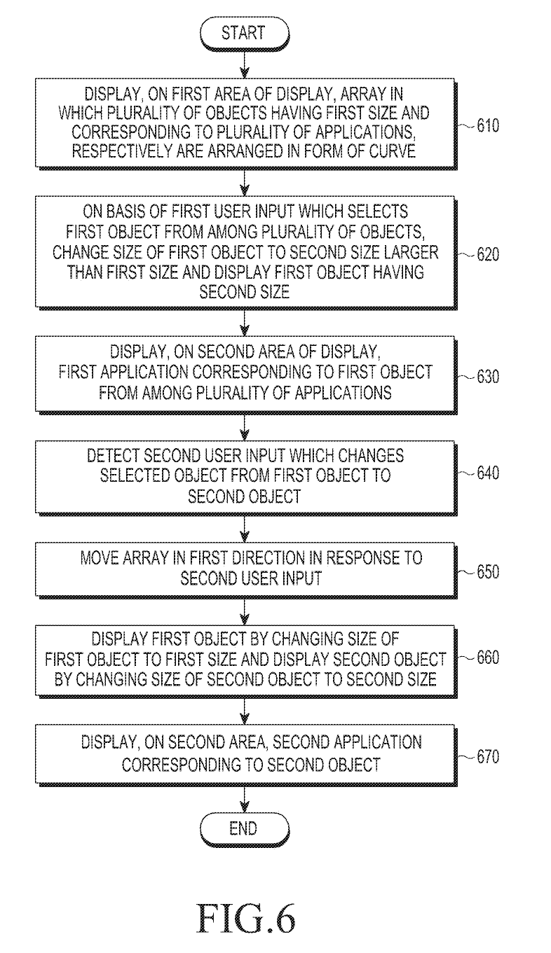

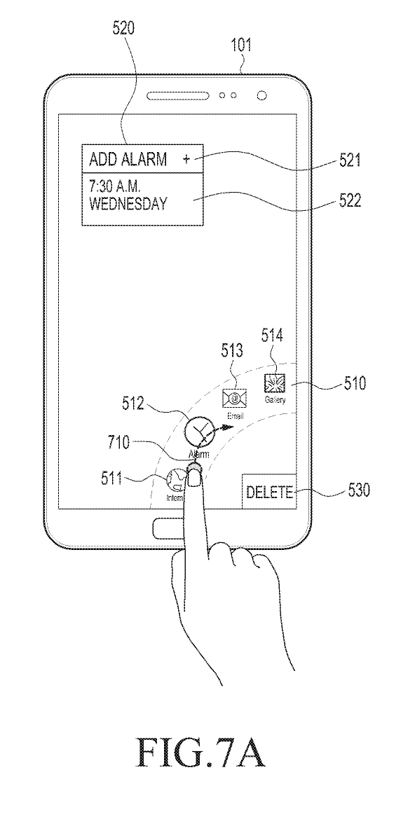

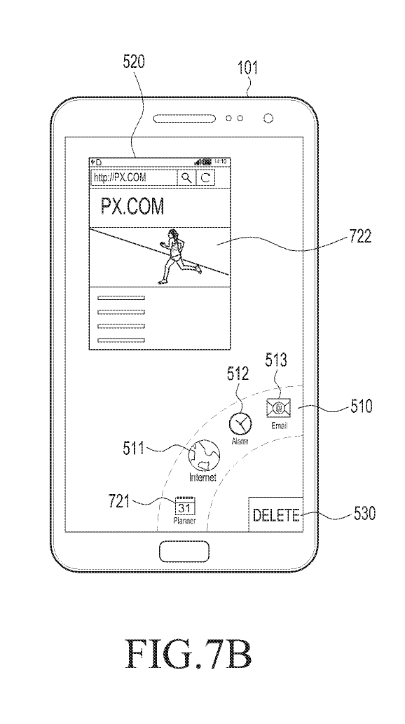

FIG. 6 is a flowchart illustrating a control method of an electronic device according to various embodiments of the present disclosure. The embodiment of FIG. 6 will be described in more detail with reference to FIGS. 7A and 7B.

FIGS. 7A and 7B are conceptual diagrams of an electronic device according to various embodiments of the present disclosure.

Referring to FIG. 6 and FIGS. 7A and 7B, in operation 610, the electronic device 101 may display, on a first area of a display, an array in which a plurality of objects having a first size and corresponding to a plurality of applications, respectively, are arranged in the form of a curve.

In operation 620, on the basis of a first user input which selects a first object from among a plurality of objects, the electronic 101 may change the first object into a second size larger than a first size and then display the first object.

In operation 630, the electronic device 101 may display, on a second area of the display, a first application corresponding to the first object from among the plurality of applications.

In operation 640, the electronic device 101 may detect a second user input which changes the selected object from the first object to a second object in order to change an application which is displayed on the second area. For example, the electronic device 101 may detect a second user input by a drag 710 performed in a first direction as in FIG. 7A.

In operation 650, in response to the second user input, the electronic device 101 may move the objects 511 to 514 on the array in the first direction. For example, as in FIG. 7B, the electronic device 101 may move a web browsing application icon 511 one step to the right, move an alarm application icon 512 one step to the right, and move an E-mail application icon 513 one step to the right. In addition, the electronic device 101 may not display a gallery application icon 514 which has been already displayed. In addition, the electronic device 101 may display, on the first area 510, a planer application icon 721 which has not been displayed yet.

In operation 660, the electronic device 101 may change the first object into the first size and the second object into the second size and then display the objects. For example, the electronic device 101 may display the alarm object 512, which has been displayed in a relatively large size, as an icon having the same size as other icons 513 and 721, and may display the web browsing application icon 511, which has been displayed in a relatively small size, as an icon relatively smaller than the other icons 512, 513, and 721. According to the present embodiment of the present disclosure, the electronic 101 may process an icon disposed in a particular location of the first area 510 as a selected icon. In response to the second user input, the electronic device 101 may move all application icons on the first area 510 in the first direction, and therefore, may change an icon selected for displaying an application on the second area 520 from the alarm object 512 to the web browsing application icon 511. The electronic device 101 may display the web browsing application icon 511 to be larger than the other icons 512, 513, and 721 so that the selected icon can be displayed to be distinguished from the other icons. Meanwhile, according to another embodiment of the present disclosure, the electronic device 101 may adjust a display attribute of the web browsing application icon 511 to be distinguished from that of the other icons 512, 513, and 721.

In operation 670, the electronic device 101 may display, on the second area 520, a second application corresponding to the second object. For example, as in FIG. 7B, the electronic device 101 may display, on the second area 520, a web browsing application execution screen 722 corresponding to the web browsing application icon 511 which is a selected icon.

According to the above description, the user may input a gesture (for example, drag-and-drop), thereby operating the electronic device 101 to change an icon selected. In addition, the user may change the selected icon, thereby operating the electronic device 101 so that the user can view execution screens corresponding to various icons in advance. In particular, according to various embodiments of the present disclosure, the electronic device 101 may allocate the input detected on the second area 520 to an application being displaying. Therefore, the user may easily input an instruction which the user wants to input while switching various applications.

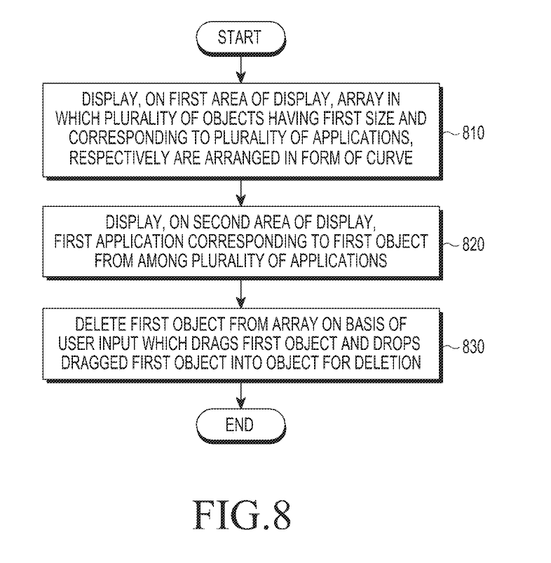

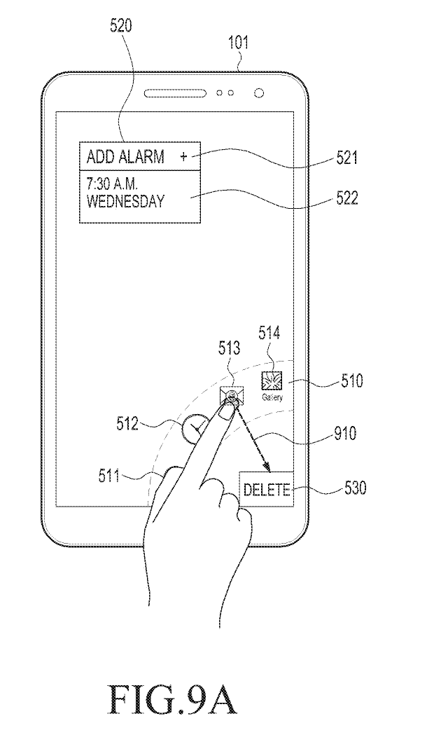

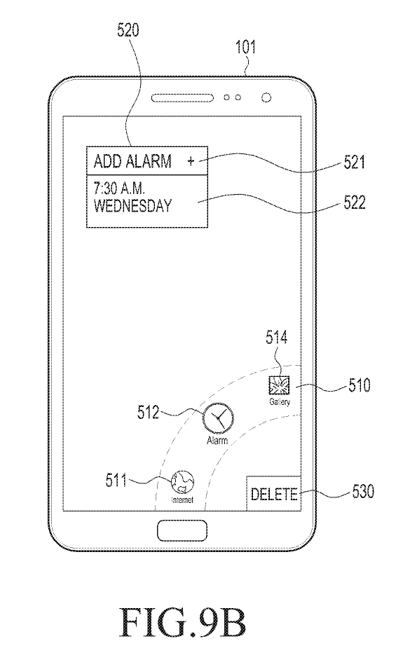

FIG. 8 is a flowchart illustrating a control method of an electronic device according to various embodiments of the present disclosure. The embodiment of FIG. 8 will be more specifically described with reference to FIGS. 9A and 9B.

FIGS. 9A and 9B are conceptual diagrams of an electronic device according to various embodiments of the present disclosure.

Referring to FIG. 8 and FIGS. 9A and 9B, in operation 810, the electronic device 101 may display, on a first area of a display, an array in which a plurality of objects having a first size and corresponding to a plurality of applications, respectively, are arranged in the form of a curve.

In operation 820, the electronic device 101 may display, on a second area of a display, an execution screen of a first application corresponding to a first object from among a plurality of applications.

In operation 830, the electronic device 101 may delete the first object from the array on the basis of a user input which drags the first object and drops the dragged first object into an object for deletion. For example, as in FIG. 9A, the electronic device 101 may detect a drag-and-drop gesture 910, which is made from an E-mail application icon 513 on the first area 510 to the object for deletion 530. As in FIG. 9B, the electronic device 101 may delete, from the first area 510, the E-mail application icon 513 corresponding to a start location of the drag-and-drop gesture 910 into the object for deletion 530. The embodiment of FIG. 9B illustrates that the electronic device 101 does not display, on the first area 510, the E-mail application icon 513 on which a deletion instruction is input, but this is merely exemplary. According to various embodiments of the present disclosure, the electronic device 101 may display another icon on the first area 510 in place of the deleted icon. Further, the electronic device 101 may move an icon, which has been in a second direction of the deleted icon, one step in place of the deleted icon, thereby controlling a certain number of icons to be displayed on the first area 510.

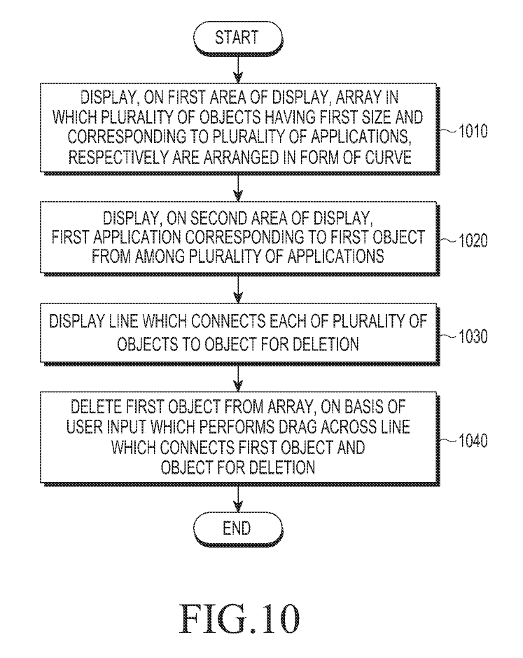

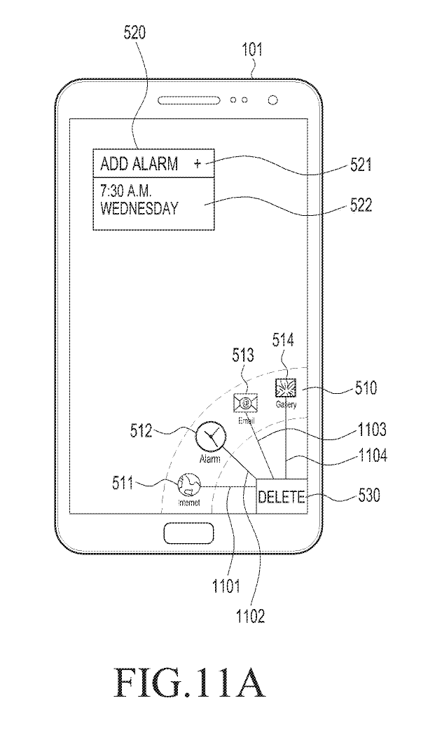

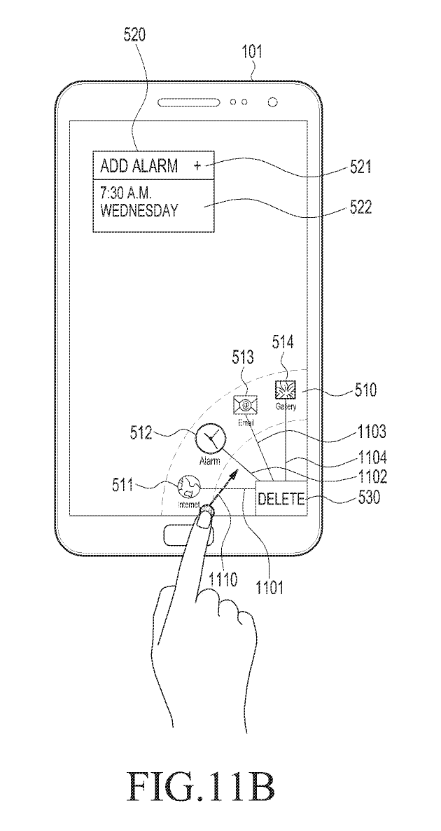

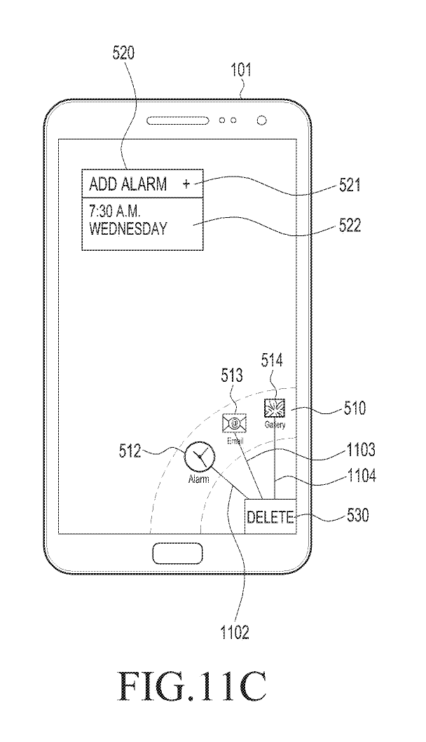

FIG. 10 is a flowchart illustrating a control method of an electronic device according to various embodiments of the present disclosure. The embodiment of FIG. 10 will be more specifically described with reference to FIGS. 11A to 11C.

FIGS. 11A to 11C are conceptual diagrams of an electronic device according to various embodiments of the present disclosure.

Referring to FIG. 10 and FIGS. 11A to 11C, in operation 1010, the electronic device 101 may display, on the first area 510 of a display, an array in which a plurality of objects having a first size and corresponding to a plurality of applications, respectively, are arranged in the form of a curve.

In operation 1020, the electronic device 101 may display, on a second area of the display, a first application corresponding to a first object from among the plurality of applications.

In operation 1030, the electronic device 101 may display a line which connects each of the plurality of objects to an object for deletion. For example, as in FIG. 11A, the electronic device 101 may display one or more lines 1101 to 1104, which connect each of the icons 511 to 514 on the first area 510 and the object for deletion 530.

In operation 1040, the electronic device 101 may delete the first object from the array on the basis of a user input which performs a drag across a line which connects the first object and the object for deletion. For example, as in FIG. 11B, the electronic device 101 may detect a drag gesture 1110 which crosses a first line 1101 connecting the icon 511 on the first area 510 and the object for deletion 530. As in FIG. 11C, the electronic device 101 may delete, from the first area 510, the web browsing application icon 511 connected to the first line 1101 in response to the detected drag gesture 1110. The embodiment of FIG. 11C illustrates that the electronic device 101 does not display, on the first area 510, the web browsing application icon 511 on which a deletion instruction is input, but this is merely exemplary. According to various embodiments of the present disclosure, the electronic device 101 may display another icon on the first area 510 in place of the deleted icon. Further, the electronic device 101 may move, one step, an icon, which has been in a second direction of the deleted icon, in place of the deleted icon, thereby controlling a certain number of icons to be displayed on the first area 510.

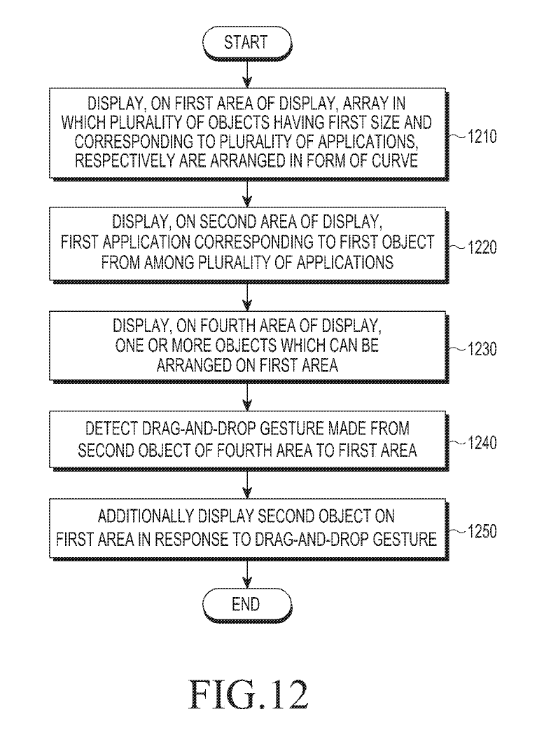

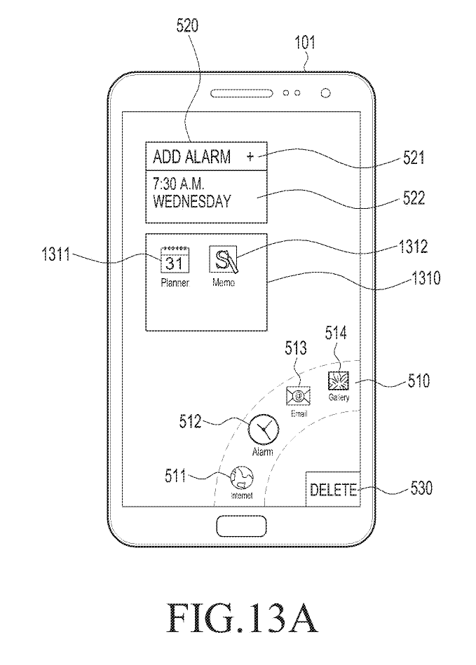

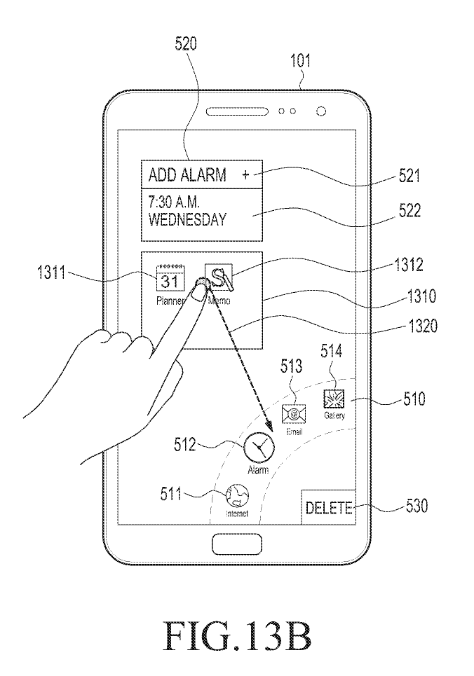

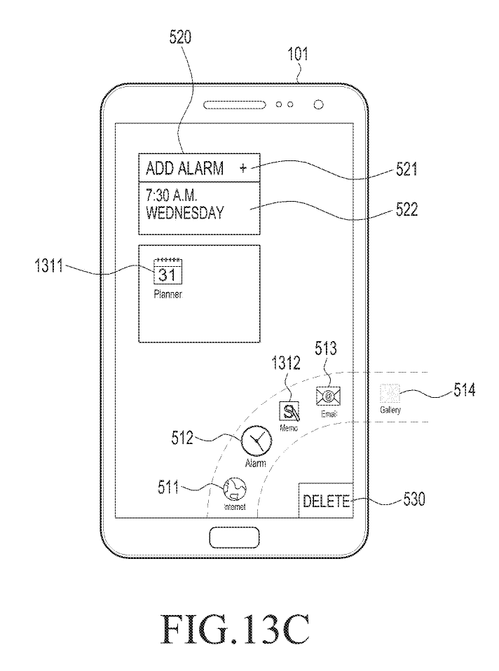

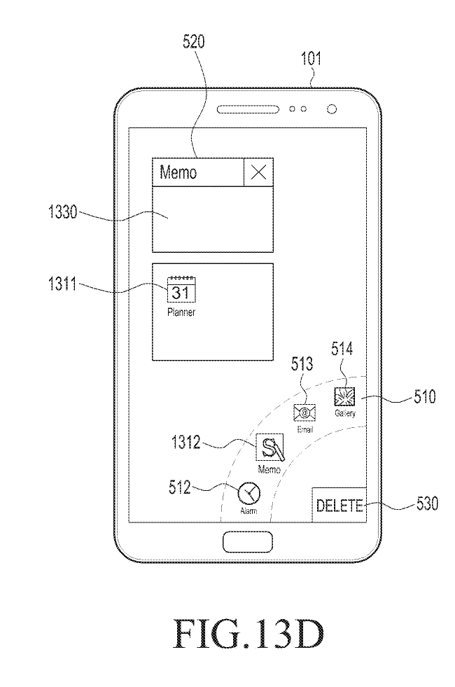

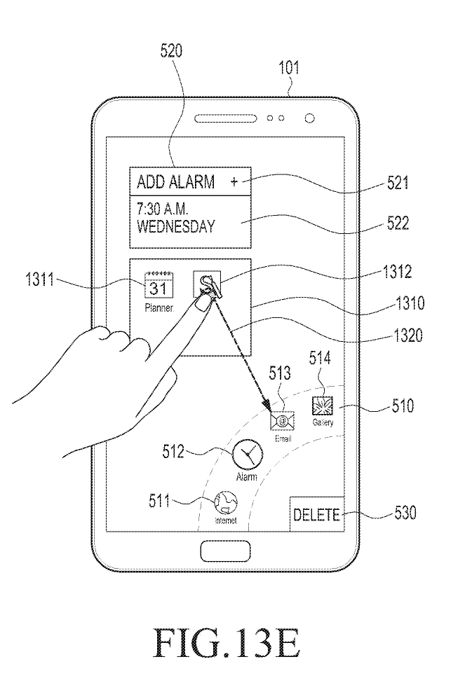

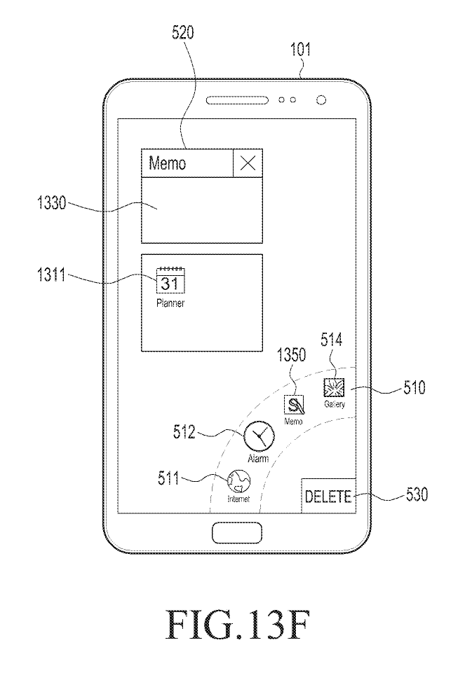

FIG. 12 is a flowchart illustrating a control method of an electronic device according to various embodiments of the present disclosure. The embodiment of FIG. 12 will be more specifically described with reference to FIGS. 13A to 13F.

FIGS. 13A to 13F are conceptual diagrams of an electronic device according to various embodiments of the present disclosure.

Referring to FIG. 12 and FIGS. 13A to 13F, in operation 1210, the electronic device 101 may display, on a first area of a display, an array in which a plurality of objects having a first size and corresponding to a plurality of applications, respectively, are arranged in the form of a curve.

In operation 1220, the electronic device 101 may display, on a second area of the display, a first application corresponding to a first object from among the plurality of applications.

In operation 1230, the electronic device 101 may display, on a fourth area of the display, one or more objects which can be arranged on the first area. For example, as in FIG. 13A, the electronic device 101 may display, on the fourth area 1310, at least one object 1311 or 1312 which can be arranged on the first area 510.

In operation 1240, the electronic device 101 may detect a gesture (for example, drag-and-drop) made from the second object of the fourth area to the first area. For example, as in FIG. 13B, the electronic device 101 may detect a drag-and-drop gesture 1320, which is made from a memo application icon 1312 on the fourth area 1310 to a first point of the first area 510. In this case, the electronic device 101 may display an animation with an effect as if being dragged by magnetic attraction.

In operation 1250, the electronic device 101 may additionally display the second object on the first area in response to the drag-and-drop gesture. For example, as in FIG. 13C, the electronic device 101 may display the memo application icon 1312 on a part of the first area 510, which corresponds to an end point of the drag-and-drop gesture 1320. The electronic device 101 may not display the memo application icon 1312 on the fourth area 1310. According to an embodiment of the present disclosure, the electronic device 101 may move the E-mail application icon 513, which has been displayed at a place of the memo application icon 1312, one step to the right and then display the E-mail application icon 513, while displaying the memo application icon 1312 on the first area 510. In addition, the electronic device 101 may not display the gallery application icon 514 on the first area 510. More specifically, the electronic device 101 may change a logical icon arrangement sequence from the gallery application icon 514—the E-mail application icon 513—the alarm object 512—the internet application icon 511 to the gallery application icon 514—the E-mail application icon 513—the memo application icon 1312—the alarm object 512—the internet application icon 511. The electronic device 101 may display only a certain number of icons, and therefore may not display the gallery application icon 514 on the first area 510. If a user input which changes an array in a second direction is detected, the electronic device 101 may not display the web browsing application icon 511 while displaying the gallery application icon 514. In addition, the electronic device 101 may display, on the second area 520, an application execution screen 1330 corresponding to the memo application icon 1312 which is the second icon from the left. Meanwhile, the displaying of the above-described certain number of icons on the first area 510 is merely exemplary. According to various embodiments of the present disclosure, the electronic device 101 may display, on the first area 510, five icons including both the memo application icon 1312 and the gallery application icon 514.

Meanwhile, the above-described icon movement from the fourth area 1310 to the first area 510 is exemplary. The electronic device 101 according to various embodiments of the present disclosure may detect a drag-and-gesture, which is made from an icon arranged on the first area 510 to the fourth area 1310, and move the icon arranged on the first area 510 to the fourth area 1310.

Meanwhile, as described above, the embodiment of the present disclosure, in which an object added to the first area 510 from the fourth area 1310 is arranged between other objects on the first area 510, is merely exemplary. According to various embodiments of the present disclosure, as in FIG. 13E, the electronic device 101 may detect a drag-and-drop gesture, which is made from the object 1312 on the fourth area 1310 to the object 513 of the first area 510. As in FIG. 13F, the electronic device 101 may display an object 1350 of the fourth area 1310 in place of the object 513 of the first area 510.

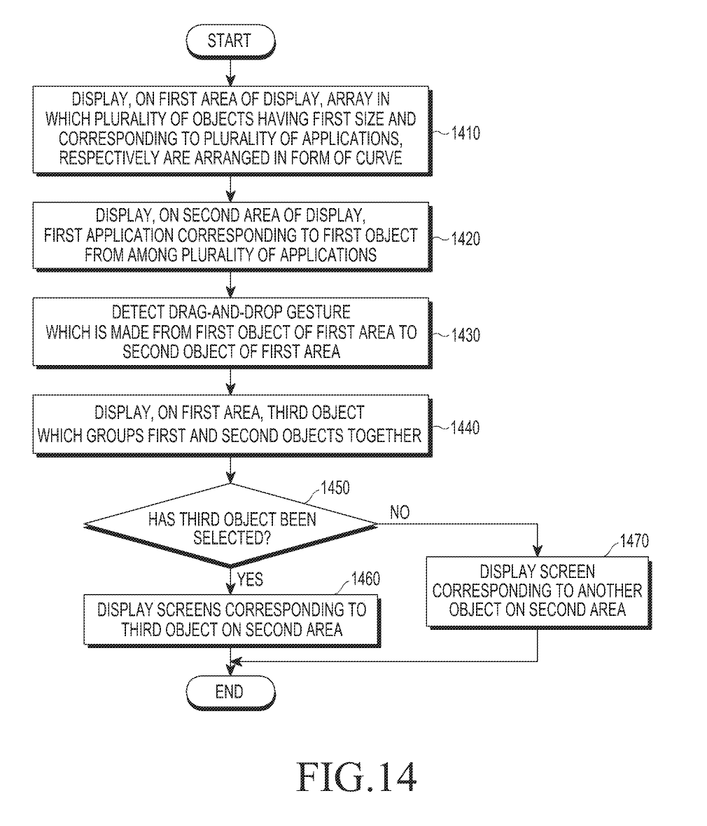

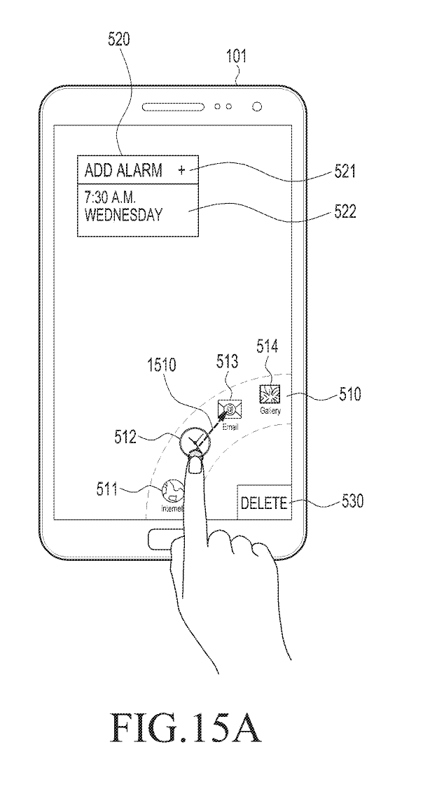

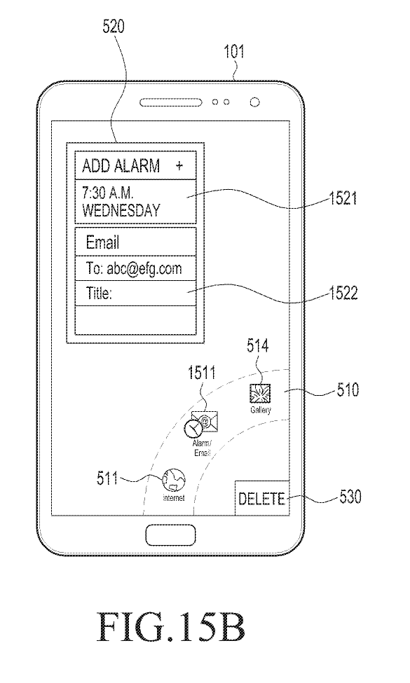

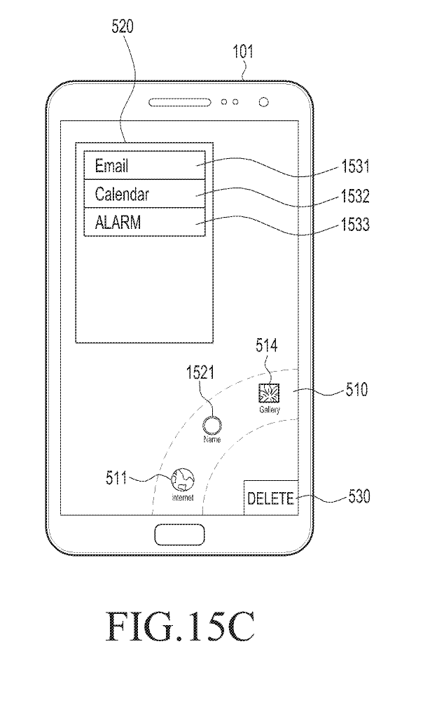

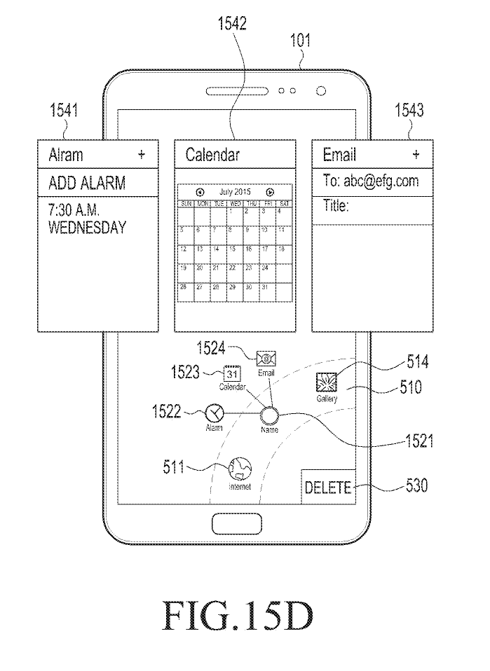

FIG. 14 is a flowchart illustrating a control method of an electronic device according to various embodiments of the present disclosure. The embodiment of FIG. 14 will be more specifically described with reference to FIGS. 15A to 15D.

FIGS. 15A to 15D are conceptual diagrams of an electronic device according to various embodiments of the present disclosure.

Referring to FIG. 14 and FIGS. 15A to 15D, in operation 1410, the electronic device 101 may display, on a first area of a display, an array in which a plurality of objects having a first size and corresponding to a plurality of applications, respectively, are arranged in the form of a curve.

In operation 1420, the electronic device 101 may display, on a second area of the display, a first application corresponding to a first object from among the plurality of applications.

In operation 1430, the electronic device 101 may detect a drag-and-drop gesture, which is made from the first object of the first area to the second object of the first area. For example, as in FIG. 15A, the electronic device 101 may detect a drag-and-drop gesture 1510, which is made from the alarm application icon 512 to the E-mail application icon 513.

In operation 1440, the electronic device 101 may display, on the first area, the third object in which the first and second objects are grouped together. For example, as in FIG. 15B, the electronic device 101 may display, on the first area 510, an icon 1511 in which an alarm application and an E-mail application are combined.

According to various embodiments of the present disclosure, the electronic device 101 may generate a new icon and name with respect to a grouped object 1521 in which a plurality of objects are grouped together, as in FIG. 15C. In this case, the electronic device 101 may generate and display the name of the icon on the basis of a user input. According to the embodiment of FIG. 15C, the electronic device 101 may display, on the first area 510, an icon 1521 in which an alarm application, a calendar application, and an E-mail application are grouped together. In addition, the electronic device 101 may display, on the second area 520, application information 1531, 1532, and 1533 corresponding to the grouped icon 1521.

According to various embodiments of the present disclosure, the electronic device 101 may display the grouped object 1521 so as to include objects to be grouped 1522, 1523, and 1524. Therefore, the user can clearly grasp which objects are included in the grouped object 1521. Meanwhile, the electronic device 101 may display, on the second area 520, at least some of application screens 1541, 1542, and 1543 corresponding to the objects to be grouped 1522, 1523, and 1524. For example, the electronic device 101 may display one application screen of the application screens 1541, 1542, and 1543 and then switch the one application screen to another application screen of the application screens 1541, 1542, and 1543 in response to a screen change request, so as to display the another application screen.

In operation 1450, the electronic device 101 may determine whether a third object is selected as an application which the user desires to display on the second area 520. When the third object is selected, in operation 1460, the electronic device 101 may display screens corresponding to the third object on the second area. For example, as in FIG. 15B, the electronic device 101 may display, on the second area 520, an alarm application execution screen 1521 and an E-mail application execution screen 1522. When the third object is not selected, in operation 1470, the electronic device 101 may display a screen corresponding to another object on the second area. Meanwhile, the displaying of an application execution screen for coupled objects as in FIG. 15B is merely exemplary. According to various embodiments of the present disclosure, the electronic device 101 may display, for example, the alarm application execution screen on the entire second area 520 and then display the E-mail application execution screen on the entire second area 520 in response to a screen switch request made by the user.

Meanwhile, according to various embodiments of the present disclosure, the electronic device 101 may perform object grouping on the basis of the detection of a drag gesture including an icon. Further, according to various embodiments of the present disclosure, the electronic device 101 may perform the object grouping on the basis of a long-press gesture input after the selection of a plurality of icons or on the basis of the detection of a drag gesture which draws a closed curve including an icon.

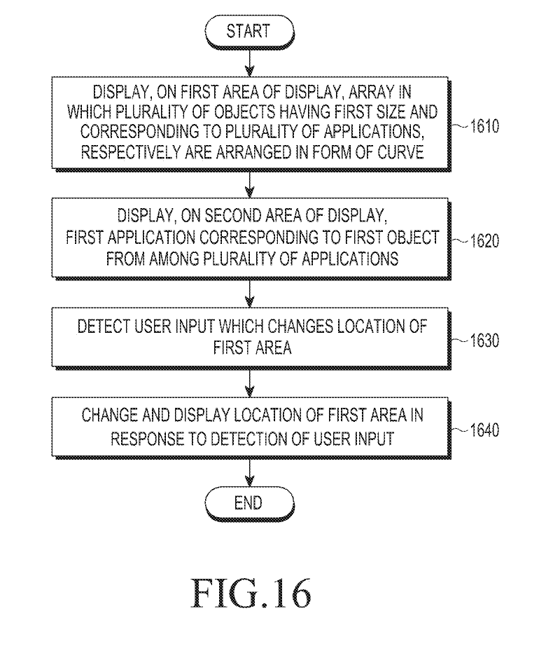

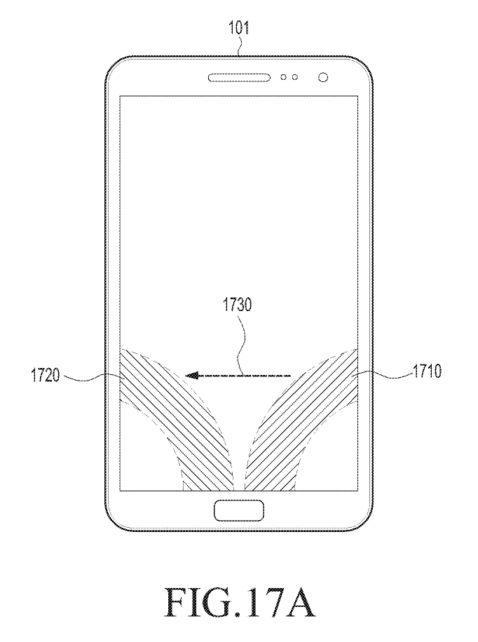

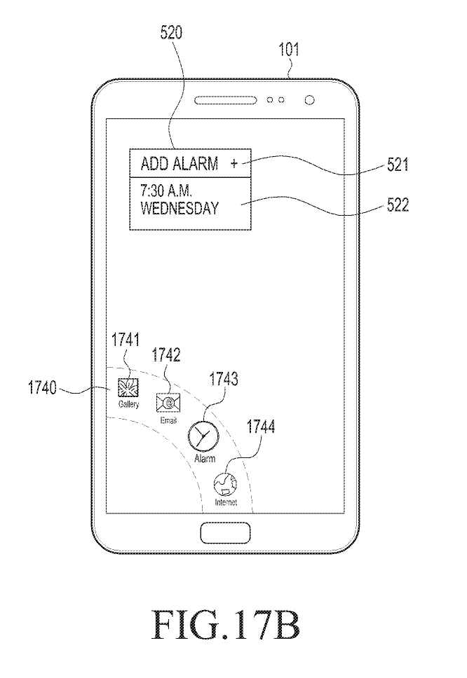

FIG. 16 is a flowchart illustrating a control method of an electronic device according to various embodiments of the present disclosure. The embodiment of FIG. 16 will be more specifically described with reference to FIGS. 17A and 17B.

FIGS. 17A and 17B are conceptual diagrams of an electronic device according to various embodiments of the present disclosure.

Referring to FIG. 16 and FIGS. 17A and 17B, in operation 1610, the electronic device 101 may display, on a first area of a display, an array in which a plurality of objects having a first size and corresponding to a plurality of applications, respectively, are arranged in the form of a curve.

In operation 1620, the electronic device 101 may display, on a second area of the display, a first application corresponding to a first object from among the plurality of applications.

In operation 1630, the electronic device 101 may detect a user input which changes the location of the first area. For example, the electronic device 101 may detect a drag gesture 1730 made from a first location 1710 of the first area to a second location 1720.

In operation 1640, the electronic device 101 may change and display the location of the first area in response to the detection of the user input. For example, as in FIG. 17B, the electronic device 101 may form a first area 1740 to be curved on the left of the display, and may form objects (for example, application icons 1741 to 1744) to be curved on the left of the display. Therefore, the electronic device 101 may change the location of the first area so that both left-handed and right-handed users can easily perform an operation thereof.

Meanwhile, according to various embodiments of the present disclosure, the electronic device 101 may detect a previous input for changing the location of the first area 510 (for example, a tap gesture in the middle of a display) and enter a mode which can change the location of the first area 510.

According to various embodiments of the present disclosure, the electronic device 101 may change the location of the first area 510 on the basis of a posture change. For example, the electronic device 101 may determine, on the basis of a signal from a gyro sensor, whether the posture of the electronic device 101 has been horizontally or vertically arranged. When the electronic device 101 is determined to be horizontally arranged, the electronic device 101 may change a displayed screen to a horizon mode so as to rotate and display the entire screen. In this case, the electronic 101 may also rotate and display the location of the first area 510 together with the entire screen.

In addition, according to various embodiments of the present disclosure, the electronic device 101 may change the location of the first area 510 in a vertical direction. In addition, the electronic device 101 may perform a change on the basis of a user's use pattern of the electronic device. For example, the electronic device 101 may learn the user's finger length, and the like, and may determine, on the basis of the finger length, at least one of the display location and display form of the first area 510.

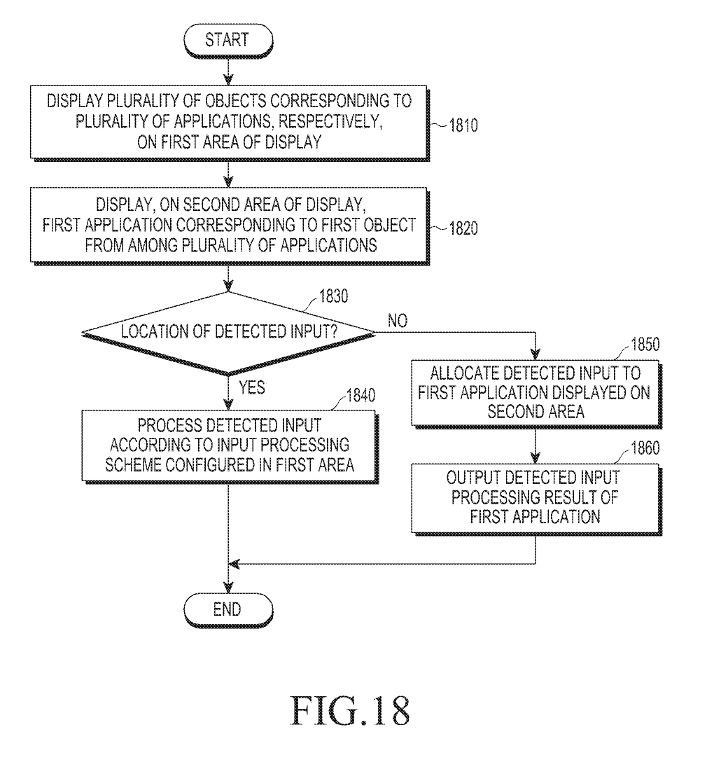

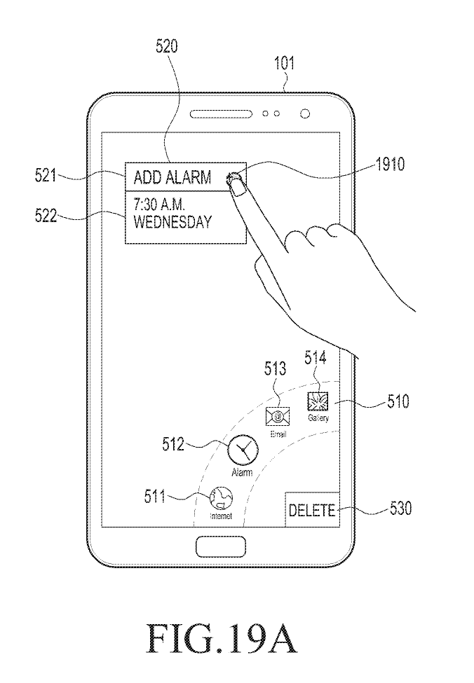

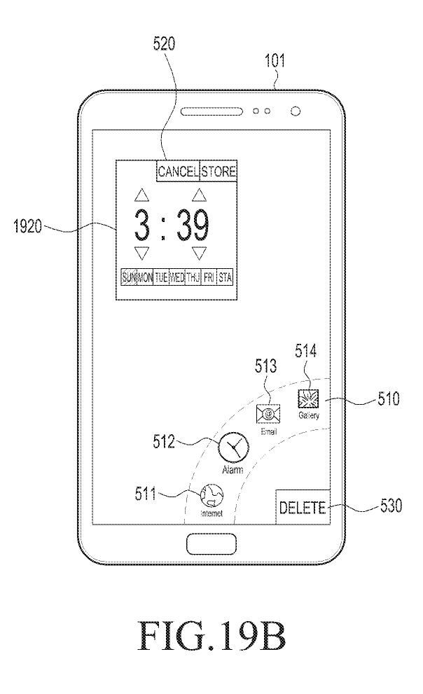

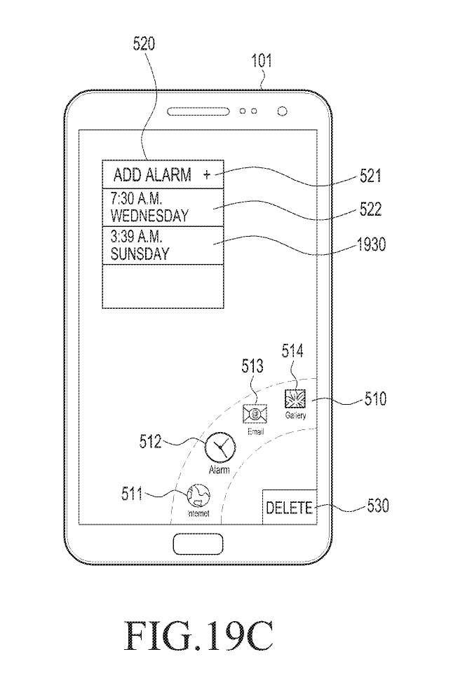

FIG. 18 is a flowchart illustrating a control method of an electronic device according to various embodiments of the present disclosure. The embodiment of FIG. 18 will be more specifically described with reference to FIGS. 19A to 19C.

FIGS. 19A to 19C are conceptual diagrams of an electronic device according to various embodiments of the present disclosure.

Referring to FIG. 18 and FIGS. 19A to 19C, in operation 1810, the electronic device 101 may display a plurality of objects corresponding to a plurality of applications, respectively, on a first area of the display.

In operation 1820, the electronic device 101 may display, on a second area of the display, a first application corresponding to a first object from among the plurality of applications. For example, as in FIG. 19A, the electronic device 101 may display, on the second area 520, the application execution screens 521 and 522 of an alarm application icon which is a selected object.

In operation 1830, the electronic device 101 may detect the location of a detected input.

When the location of the detected input is in the first area 510, in operation 1840, the electronic device 101 may process the detected input according to an input processing scheme configured in the first area 510. For example, the electronic device 101 may use the input detected in the first area 510 in selecting an object, moving an object location, changing an object arrangement sequence, deleting/adding an object, and the like. When the location of the detected input is in the second area 520, in operation 1850, the electronic device 101 may allocate the detected input to a first application displayed on the second area. In operation 1860, the electronic device 101 may output a detected input processing result of the first application. For example, as in FIG. 19A, the electronic device 101 may allocate a user input 1910 performed on the second area 520 to an alarm application which is being displayed on the second area 520. Therefore, as in FIG. 19B, the electronic device 101 may display an alarm application execution screen 1920, which is a result obtained by processing the user input 1910. For example, the electronic device 101 may display the application execution screen 1920 of an alarm addition screen in response to the designation of an object of alarm addition 521. The user may additionally input a user input on the application execution screen 1920 of the second area 520, and the electronic device 101 may display, on the second area 520, application execution screens 521, 522, and 1930 on which the input detected in the second area 520 is processed. As in FIG. 19C, the electronic device 101 may further display the application execution screen 1930 on which an alarm is added.

According to the above description, the electronic device 101 may display an application icon on the first area 510 and may simultaneously provide a function of directly operating an application which is being displayed on the second area 520.

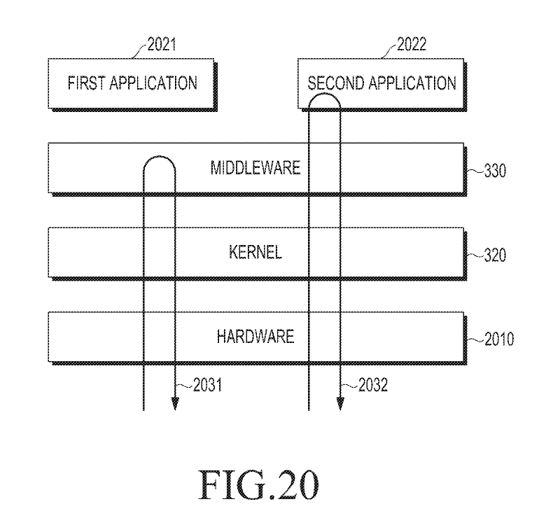

FIG. 20 is a block diagram of a program module according to various embodiments of the present disclosure.

Referring to FIG. 20, the electronic device 101 may allocate, to the middleware layer 330, a first input 2031 input to the kernel layer 320 via a hardware layer 2010. For example, the electronic device 101 may allocate the first input 2031 detected in the first area of the display to the middleware layer 330, but not to an application layer, for example, a first application 2021. The allocated first input 2031 may be used in middleware layer 330. For example, the window manager or the application manager may change and display an application screen displayed on the second area 520. Meanwhile, according to various embodiments of the present disclosure, the electronic device 101 may use the first input 2031, which is detected on the first area, in the application layer so as to change a display of the first area.

The electronic device 101 may allocate a second input 2032 input to the kernel layer 320 via the hardware layer 2010 to an application layer, for example, a second application 2022. For example, the electronic device 101 may allocate the second input 2032 detected in the second area of the display to the application layer, for example, the second application 2022. The second application 2022 may output a processing result by using the allocated second input 2032, and the electronic device 101 may output the output processing result through the hardware layer 2010.

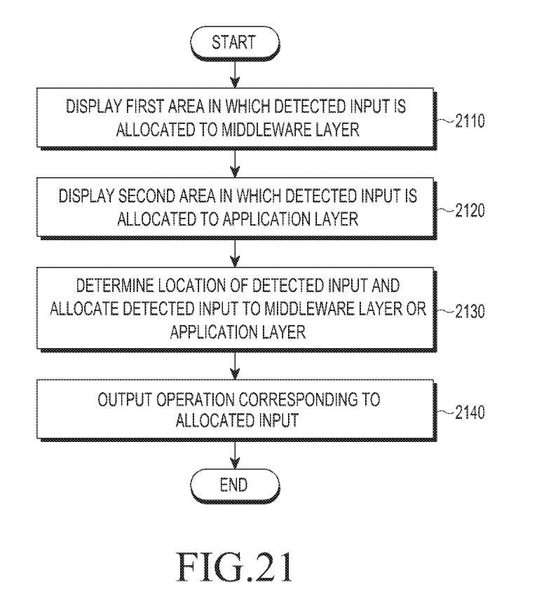

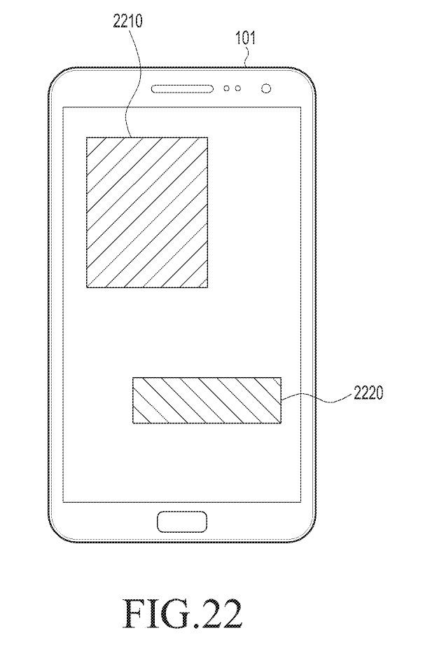

FIG. 21 is a flowchart illustrating a control method of an electronic device according to various embodiments of the present disclosure. The embodiment of FIG. 21 will be more specifically described with reference to FIG. 22.

FIG. 22 is a conceptual diagram illustrating an area according to various embodiments of the present disclosure.

Referring to FIGS. 21 and 22, in operation 2110, the electronic device 101 may display a first area in which a detected input is allocated to the middleware layer.

In operation 2120, the electronic device 101 may display a second area in which a detected input is allocated to the application layer. For example, the electronic 101 may configure a first area 2220 and a second area 2210 on a display, as in FIG. 22. In other words, the electronic device 101 may separately configure an area in which the detected input is allocated to the middleware layer and an area in which the detected input is allocated to the application layer.

In operation 2130, the electronic device 101 may determine the location of the detected input and allocate the detected input to the middleware layer or the application layer.

In operation 2140, the electronic device 101 may output an operation corresponding to the allocated input.

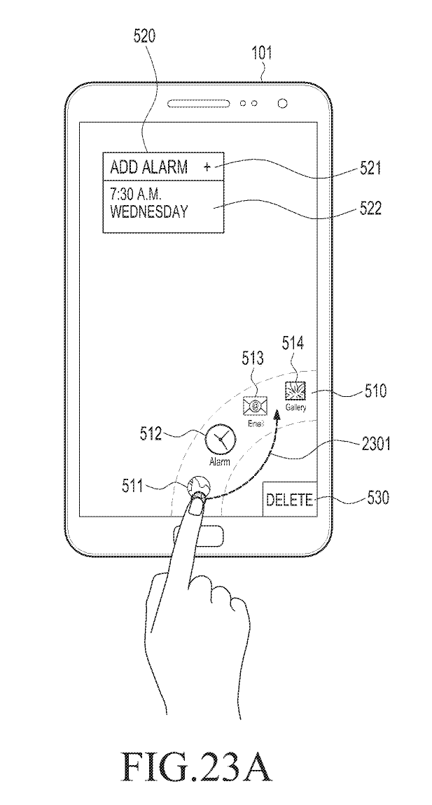

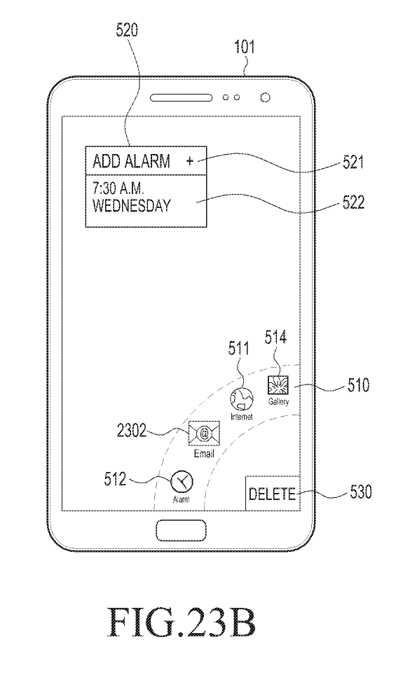

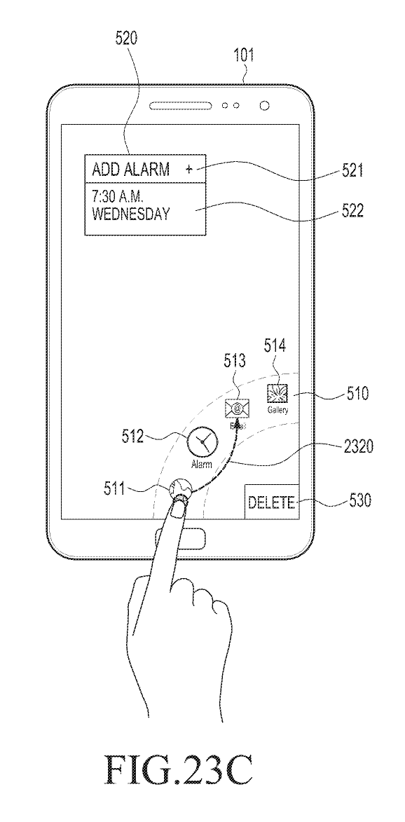

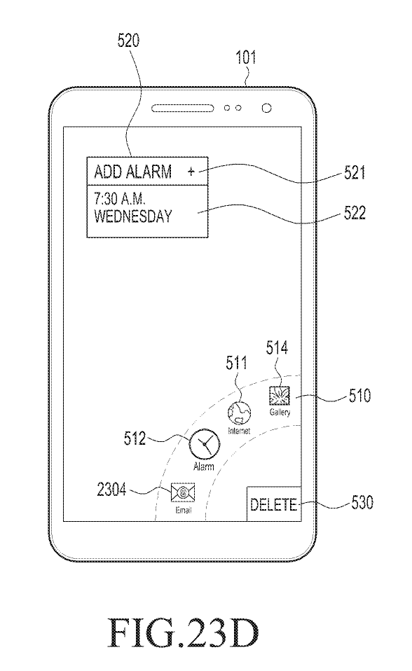

FIGS. 23A to 23D are conceptual diagrams of an electronic device according to various embodiments of the present disclosure.

Referring to FIG. 23A, the electronic device 101 may detect a gesture (for example, drag-and-drop) 2301, which moves the web browsing application icon 511 on the first area 510 from a first point on the first area 510 to a second point on the first area 510. The electronic device 101 may interpret and process the drag-and-drop gesture 2301 as an icon location movement gesture, the gesture being made from an icon to a point which is not an icon.

Referring to FIG. 23B, the electronic device 101 may move the web browsing application icon 511, which is an icon to be moved, between the E-mail application icon 513 and the gallery application icon 514. In other words, the electronic device 101 may change a logical icon arrangement sequence from the gallery application icon 514—the E-mail application icon 513—the alarm application icon 512—the web browsing application icon 511 to the gallery application icon 514—the web browsing application icon 511—the E-mail application icon 2302—the alarm application icon 512. Meanwhile, the electronic device 101 may maintain displaying alarm application execution screens 521 and 522 on the second area 520. According to another embodiment of the present disclosure, the electronic device 101 may arrange an E-mail application icon 2302 at the second location from the left, in response to the above-described change in an icon arrangement sequence. As described above, according to various embodiments of the present disclosure, the electronic 101 may determine an icon arranged in a particular location (for example, the second location from the left) of the first area 510 as a selected icon. Therefore, the electronic device 101 may display the E-mail application icon 2302, which is the second icon from the left, to be distinguished from other icons 511, 512, and 514. For example, the electronic device 101 may display the size of the E-mail application icon 2302 to be larger than the other icons. In addition, the electronic device 101 may display, on the second area 520, an E-mail application execution screen corresponding to the selected icon, i.e., the E-mail application icon 2302.

FIGS. 23C and 23D are conceptual diagrams illustrating a location movement of an object according to various embodiments of the present disclosure.

Referring to FIG. 23C, the electronic device 101 may detect a drag gesture 2320 made from the first object 511 to the third object 513.

Referring to FIG. 23D, when an end point of the drag gesture 2320 is determined to exceed a threshold of a boundary of the third object 513, the electronic device 101 may display a new object 2304 on the first area 510 while displaying an animation effect, such as crowding out the third object 513.

According to various embodiments of the present disclosure, the electronic device 101 may change the locations of the first object 511 and third object 513 to each other and then display the locations, in response to the drag gesture 2320 made from the first object 511 to the third object 513.

According to various embodiments of the present disclosure, a control method of an electronic device including a display may include displaying, on a first area of the display, an array in which a plurality of objects corresponding to a plurality of applications are arranged in the form of a curve, displaying a first object to be distinguished from other objects on the basis of a first user input selecting the first object from among the plurality of objects, displaying, on a second area of the display, a first application corresponding to the first object among the plurality of applications, and displaying, on a third area of the display, an object for deletion which is configured to delete at least some of the plurality of objects.

According to various embodiments of the present disclosure, the displaying of the first object to be distinguished from other objects may change, in response to the first user input, the first object having a first size into the first object having a second size and then display the first object having the second size.

According to various embodiments of the present disclosure, the displaying of the first object to be distinguished from other objects may change, in response to the first user input, the first object having a first display attribute into the first object having a second display attribute and then display the first object having the second display attribute.

According to various embodiments of the present disclosure, a control method of an electronic device may further include moving the array in a first direction on the display, on the basis of a second user input which performs a drag in the first direction input in the first area, and displaying a second object, which is located in a second direction opposite to the first direction with respect to the first object, to be distinguished from the remaining objects excluding the second object.

According to various embodiments of the present disclosure, the displaying of a second object to be distinguished from the remaining objects excluding the second object may change the size of the first object from the second size to the first size and change the size of the second object from the first size to the second size.

According to various embodiments of the present disclosure, a control method of an electronic device may further include deleting the first object from the array on the basis of the second user input which drags the first object and drops the dragged first object into the object for deletion.

According to various embodiments of the present disclosure, a control method of an electronic device may further include displaying a plurality of lines which connect each of the plurality of objects to the object for deletion, and deleting, from the array, the second object connected to one selected line among the plurality of objects on the basis of the second user input selecting the one selected line from among the plurality of lines.

According to various embodiments of the present disclosure, a control method of an electronic device may further include editing at least one of the sequence of objects and at least one of objects which constitute the array.

According to various embodiments of the present disclosure, a control method of an electronic device may further include detecting the second user input designating the second object from among the first object and the plurality of objects, and displaying an object in which the first and second objects are grouped together, in place of the first and second objects.

According to various embodiments of the present disclosure, a control method of an electronic device may further include displaying, on the second area, a first application corresponding to the first object and a second application corresponding to the second object when the grouped object is selected.

According to various embodiments of the present disclosure, a control method of an electronic device may further include determining, on the basis of a user's use pattern of the electronic device, at least one of a display location and display form of the first area.

According to various embodiments of the present disclosure, a control method of an electronic device may include displaying a first area in which a detected input is allocated to a middleware layer, displaying a second area in which a detected input is allocated to an application layer, allocating an input detected in the first area to the middleware layer or allocating an input detected in the second area to the application layer, and outputting an operation corresponding to the allocated input.

According to various embodiments of the present disclosure, a control method of an electronic device may further include displaying, on the second area, an execution screen of an application corresponding to one of objects on the first area.

According to various embodiments of the present disclosure, a control method of an electronic device may further include allocating the input detected in the second area to the application.

According to various embodiments of the present disclosure, a control method of an electronic device may further include determining and displaying an application which is displayed on the second area, in response to the input detected in the first area.

According to various embodiments of the present disclosure, a control method of an electronic device may further include displaying the plurality of objects on the first area, wherein the first object selected from among the plurality of objects is linked with the second area.

According to various embodiments of the present disclosure, in a storage medium storing instructions, the instructions are configured to instruct at least one processor to perform at least one operation when the instructions are executed by the at least one processor, wherein the at least one operation may include displaying, on the first area of the display, an array in which a plurality of objects corresponding to a plurality of applications, respectively, are arranged in the form of a curve.

According to various embodiments of the present disclosure, a control method of an electronic device may include displaying a first object to be distinguished from other objects on the basis of a first user input selecting the first object from among the plurality of objects, displaying, on a second area of the display, a first application corresponding to the first object among the plurality of applications, and displaying, on a third area of the display, an object for deletion which is configured to delete at least some of the plurality of objects.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display;
a processor that is electrically connected to the display; and
a memory that is electrically connected to the processor, wherein the memory, at a time of execution, is configured to store instructions that instruct the processor to:
display, on a first area of the display, an array in which a plurality of objects corresponding to a plurality of applications are arranged in a form of a curve,
display a first object to be distinguished from other objects based on a first user input selecting the first object from among the plurality of objects,
display, on a second area of the display, a first application corresponding to the first object among the plurality of applications, and
display, on a third area of the display, an object for deletion which is configured to delete at least some of the plurality of objects.

2. The electronic device of claim 1, wherein the memory, at the time of execution, is further configured to store an instruction that instructs the processor to:
change, in response to the first user input, the first object having a first size into the first object having a second size, and
display the first object having the second size.

3. The electronic device of claim 1, wherein the memory, at the time of execution, is further configured to store an instruction that instructs the processor to:
change, in response to the first user input, the first object having a first display attribute into the first object having a second display attribute, and
display the first object having a second attribute.

4. The electronic device of claim 1, wherein the memory, at the time of execution, is further configured to store an instruction that instructs the processor to:
move the array in a first direction on the display, based on a second user input which performs a drag in the first direction input in the first area, and
display a second object, which is located in a second direction opposite to the first direction with respect to the first object, to be distinguished from the remaining objects excluding the second object.

5. The electronic device of claim 4, wherein the memory, at the time of execution, is further configured to store an instruction that instructs the processor to:
change the second size of the first object to the first size, and
change the first size of the second object to the second size.

6. The electronic device of claim 1, wherein the memory, at the time of execution, is further configured to store an instruction that instructs the processor to:
delete the first object from the array, based on the second user input which drags the first object, and
drop the dragged first object into the object for deletion.

7. The electronic device of claim 1, wherein the memory, at the time of execution, is further configured to store an instruction that instructs the processor to edit at least one of the sequence of objects and at least one of objects which constitute the array.

8. The electronic device of claim 1, wherein the memory, at the time of execution, is further configured to store an instruction that instructs the processor to:
detect the second user input designating the second object from among the first object and the plurality of objects, and
display an object in which the first and second objects are grouped together, in place of the first and second objects.

9. The electronic device of claim 8, wherein the memory, at the time of execution, is further configured to store an instruction that instructs the processor to display, on the second area, a first application corresponding to the first object and a second application corresponding to the second object, when the grouped object is selected.

10. The electronic device of claim 1, wherein the memory, at the time of execution, is further configured to store an instruction that instructs the processor to determine at least one of a display location and display form of the first area, based on a user's use pattern of the electronic device.

11. A control method of an electronic device comprising a display, the control method comprising:
displaying, on a first area of the display, an array in which a plurality of objects corresponding to a plurality of applications are arranged in a form of a curve;
displaying a first object to be distinguished from other objects based on a first user input selecting the first object from among the plurality of objects;
displaying, on a second area of the display, a first application corresponding to the first object among the plurality of applications; and
displaying, on a third area of the display, an object for deletion which is configured to delete at least some of the plurality of objects.

12. The control method of claim 11, wherein the displaying of the first object to be distinguished from other objects comprises:
changing, in response to the first user input, the first object having a first size into the first object having a second size, and
displaying the first object having the second size.

13. The control method of claim 11, wherein the displaying of the first object to be distinguished from other objects comprises:
changing, in response to the first user input, the first object having a first display attribute into the first object having a second display attribute, and
displaying the first object having the second display attribute.

14. The control method of claim 11, further comprising:
moving the array in a first direction on the display, based on a second user input which performs a drag in the first direction input in the first area, and
displaying a second object, which is located in a second direction opposite to the first direction with respect to the first object, to be distinguished from the remaining objects excluding the second object.

15. The control method of claim 14, wherein the displaying of a second object to be distinguished from the remaining objects excluding the second object comprises:
changing the second size of the first object to the first size and
changing the first size of the second object to the second size.

16. The control method of claim 11, further comprising:
deleting the first object from the array based on the second user input which drags the first object and drops the dragged first object into the object for deletion.

17. The control method of claim 11, further comprising:
editing at least one of the sequence of objects and at least one of objects which constitute the array.

18. The control method of claim 11, further comprising:
detecting the second user input designating the second object from among the first object and the plurality of objects; and
displaying an object in which the first and second objects are grouped together, in place of the first and second objects.

19. The control method of claim 11, further comprising:
displaying, on the second area, a first application corresponding to the first object and a second application corresponding to the second object when the grouped object is selected.

20. The control method of claim 11, further comprising:
determining at least one of a display location and display form of the first area, based on a user's use pattern of the electronic device.
